(19) United States
(12) Patent Application Publication
(10) Pub. No.: US 2012/0252967 A1
(43) Pub. Date: Oct. 4, 2012

(54) POLYURETHANES

(75) Inventors: Francesca Ercole, Balwyn (AU); Florian Hans Maximilian Graichen, Richmond (AU); Stella Kyi, Dandenong North (AU); Michael Shane O'Shea, Mulgrave (AU); Andrew Charles Warden, Ngunnawai (AU)

(73) Assignees: Grains Research and Development Corporation, Barton (AU); Commonwealth Scientific and Industrial Research Organisation, Campbell (AU)

(21) Appl. No.: 12/988,466

(22) PCT Filed: Apr. 17, 2009
(86) PCT No.: PCT/AU2009/000480

§ 371 Date: May 13, 2011

(30) Foreign Application Priority Data
Apr. 18, 2008 (AU) 2008901958

(51) Int. Cl. C08G 18/28; C09J 175/06; C09D 175/06

(52) U.S. Cl. 524/590; 528/80

(57) ABSTRACT

The present invention relates to a polyurethane polymer comprising as part of its polymer backbone an α-oxy carbonyl moiety of general formula (I), where A and B represent the remainder of the polymer backbone and are the same or different, and R is an optionally substituted aliphatic hydrocarbon having three or more carbon atoms.

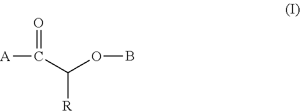

### FIELD OF THE INVENTION

The present invention relates in general to polyurethane polymers. In particular, the invention relates to polyurethane polymers comprising ester, ether, amide and/or urea linkages and to a method of preparing the same.

### BACKGROUND OF THE INVENTION

A characteristic feature of polyurethane polymers is that they comprise urethane linkages (i.e. —NHC(O)O—) that are coupled so as to form a polymer backbone. The polymer backbone may be liner or branched. The urethane linkages are typically formed through reaction of an isocyanate group (—N═C═O) with a hydroxyl group (—OH), and the polymers are typically produced by a polyaddition reaction of a polyisocyanate (i.e. a compound comprising two or more isocyanate functional groups) with a polyalcohol (i.e. a compound comprising two or more hydroxyl groups—commonly referred to as a polyol).

Isocyanate functional groups are known to react with most compounds that contain an active hydrogen atom. Thus, the reaction of an isocyanate group with a carboxylic acid group (—COOH) can provide for an amide linkage (i.e. —C(O)NH—) with the liberation of CO₂. Compounds comprising both a carboxylic acid group and a hydroxyl group (i.e. a hydroxy-acid) may therefore give rise to both an amide linkage and a urethane linkage. The reaction of an isocyanate group with an amine can provide for a urea linkage (i.e. —NHC(O)NH—). A urea linkage may also result through the reaction of water with an isocyanate group to form an unstable carbamic acid group, that in turn decomposes forming carbon dioxide and an amine group. The amine group may then react with a further isocyanate group to give rise to the urea linkage.

The reaction versatility of isocyanate functional groups enables polyurethane polymers to be manufactured with a variety of compositions. Thus, the use of polyester polyols, polyether polyols, hydroxycarboxylic acids, amines/water in the manufacture of polyurethanes polymers will give rise to ester, ether, amide and urea linkages also being present in the polymer backbone.

Depending upon the type and amount and reagents used during manufacture, polyurethane polymers may be prepared with a diverse array of physical and chemical properties. For example, polyurethanes may vary widely in their stiffness, hardness, elasticity, tensile strength and density, and may or may not be susceptible to biodegradation.

In view of such varied physical and chemical properties, polyurethanes may be used in the manufacture of soft and rigid foam materials, elastomeric materials, flexible and rigid moulded products, coating products, sealants and adhesives.

Despite the variety of polyurethanes presently available, there remains an opportunity to develop new polyurethane polymers that demonstrate further utility for this class of polymer.

### SUMMARY OF THE INVENTION

The present invention therefore provides a polyurethane polymer comprising as part of its polymer backbone an α-oxy carbonyl moiety of general formula (I):

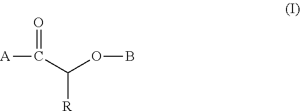

where A and B represent the remainder of the polymer backbone and are the same or different, and R is an optionally substituted aliphatic hydrocarbon having three or more carbon atoms.

In one embodiment of the invention, the α-oxy carbonyl moiety is present in a portion of the polymer backbone represented by general formula (II):

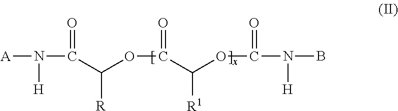

where A, B and R are as hereinbefore defined, R¹ is an optionally substituted aliphatic hydrocarbon, and x may be 0 or a positive integer ranging from 1 to 100, for example 1 to 50, or 1 to 25, or 1 to 5, wherein for each repeat unit x when x≧2, R¹ is the same or different.

In a further embodiment, the α-oxy carbonyl moiety is present in a portion of the polymer backbone represented by general formula (III):

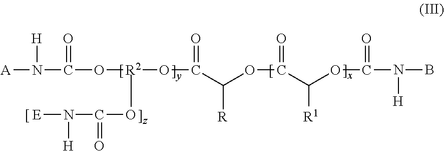

where A, B, R, R¹ and x are as hereinbefore defined, E represents with A and B the remainder of the polymer backbone, R² is a z+2 valent moiety selected from optionally substituted alkylene, optionally substituted alkenylene, optionally substituted arylene, and optionally substituted alkylene-arylene-alkylene, and y is an integer ranging from 1 to 100, for example 1 to 50, or 1 to 25, or 1 to 5, wherein for each repeat unit y when y≧2 R² is the same or different, and z is 0 or an integer ranging from 1 to 20, for example 1 to 10, or 1 to 5.

The present invention also provides a method of preparing a polyurethane polymer, said method comprising forming a urethane linkage through reaction of a compound comprising an isocyanate functional group and a compound of general formula (IV):

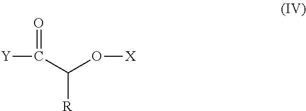

where Y is OH or —[—O—R²(OH)_{z}—]_{y}—OH, X is H or —[—C(O)CH(R¹)O—]ₓ—H, and R, R¹, R², x, y and z are as hereinbefore defined.

The present invention further provides for the use of a compound of general formula (IV) in the manufacture of a polyurethane polymer.

The present invention also provides a foam, elastomeric, moulded, coatings, fibre, sealant or adhesive product comprising a polyurethane polymer in accordance with the invention.

Those skilled in the art will appreciate that the α-oxy carbonyl moiety of general (I) that forms part of the polymer backbone is the residue of an α-hydroxy fatty acid. The fatty R group of the α-oxy carbonyl moiety can advantageously introduce pendent hydrophobic character to the polyurethane polymer that is believed to give rise to new and/or improved properties to this class of polymer.

The α-hydroxy fatty acids also present as an alternative building block in the manufacture of polyurethane polymers, and in particular, are a renewable resource that can be derived from plants and animals.

Further aspects of the invention are described below.

### BRIEF DESCRIPTION OF THE DRAWINGS

Preferred embodiments of the invention will hereinafter be illustrated by way of example only with reference to the accompanying drawing in which:

FIG. 1 illustrates a ¹H-NMR spectrum of a polyurethane polymer in accordance with the invention (Example 31f).

FIG. 2 illustrates a ¹H-NMR spectrum of a polyurethane polymer in accordance with the invention (Example 17).

FIG. 3 illustrates a ¹H-NMR spectrum of a polyurethane polymer in accordance with the invention (Example 35a).

FIG. 4 illustrates Tensile-Lap Shear test data (low strain rate) of a polyurethane polymer in accordance with the invention as an adhesive between aluminium strips (Example 31).

FIG. 5 illustrates Tensile-Lap Shear test data (high strain rate) of a polyurethane polymer in accordance with the invention as an adhesive between aluminium strips (Example 31).

FIG. 6 illustrates Tensile-Lap Shear test data (low strain rate) of a polyurethane polymer in accordance with the invention as an adhesive between polyethylene strips (Example 31).

FIG. 7 illustrates Tensile-Lap Shear test data (high strain rate) of a polyurethane polymer in accordance with the invention as an adhesive between polyethylene strips (Example 31).

### DETAILED DESCRIPTION OF THE INVENTION

As used herein, the term “polyurethane” or “polyurethane polymer” has the common meaning as would be understood by those skilled in the art. Polyurethanes comprise coupled urethane linkages (i.e. —NHC(O)O—) that form part of the polymer's backbone.

Polyurethanes may also include within their polymer backbone ester, ether, amide and/or urea linkages. In that case, the polyurethanes might also be referred to as a polyurethane -ester, -ether, -amide, and/or -urea.

By the expression “polymer backbone” of the polyurethane is meant the main structure of the polymer on to which substituents may be attached. The main structure of the polymer may be linear or branched.

By the polyurethane polymer comprising the α-oxy carbonyl moiety as “part of its polymer backbone” is meant that the α-oxy carbonyl moiety functions a divalent moiety within the main structure of the polymer chain. In other words, unlike the R group of the α-oxy moiety, the α-oxy carbonyl moiety per se is not pendant from the polymer backbone. Having said this, it will be appreciated that the α-oxy carbonyl moiety may form part of branch arm or limb of the polymer backbone.

The α-oxy carbonyl moiety is represented by general formula (I):

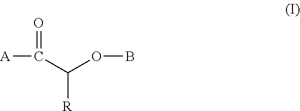

A and B in general formula (I) represent the remainder of the polymer backbone and may be the same or different. A and B may therefore comprise conventional polyurethane structures. The α-oxy carbonyl moiety in general formula (I), and also that in related general formulae described herein, may therefore more simplistically be represented as general formula (Ia):

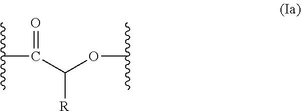

Polyurethanes in accordance with the invention will generally contain multiple α-oxy carbonyl moieties of general formula (I).

R in general formula (I) is an optionally substituted aliphatic hydrocarbon having three or more carbon atoms. By “aliphatic” hydrocarbon is meant a non-aromatic hydrocarbon. For avoidance of any doubt, it is the aliphatic hydrocarbon that is intended to have the three of more carbon atoms. In other words, if present, an optional substituent is not intended to contribute to the “three or more carbon atoms”. The hydrocarbon group R may also be an acyclic hydrocarbon (i.e. a non-cyclic hydrocarbon). The hydrocarbon group R may be a linear or branched alkyl, alkenyl, or alkynyl group.

The hydrocarbon group R may be saturated or unsaturated. Where the hydrocarbon is unsaturated, it may be mono- or poly-unsaturated, and include both cis- and trans-isomers.

The hydrocarbon R will generally have 3 to 40 carbon atoms, for example 3 to 20 carbon atoms, or 6 to 20 carbon atoms. The hydrocarbon R may be substituted, for example with a hetero atom containing moiety and/or an aromatic or cyclic moiety. In some embodiments the R group is not substituted.

Where the R group in general formula (I) is an unsaturated aliphatic hydrocarbon group, or an aliphatic hydrocarbon group substituted with one or more optional substituents as herein defined that present a reactive functional group, the modified condensation polymers in accordance with the invention can advantageously undergo reaction through the reactive functional groups within or substituted on the hydrocarbon R. For example, where the hydrocarbon group R is unsaturated, the unsaturated bonds may take part in crosslinking reactions (i.e. oxidative crosslinking similar to that which occurs in alkyd paints, or free radical mediated reactions), and free radical mediated grafting reactions. Crosslinking and grafting reactions may also be conducted through reactive functional group substituents on the hydrocarbon group R.

Providing the hydrocarbon group R with one or more reactive functional groups can advantageously enable organic or inorganic moieties to be tethered to the polymer backbone through reaction of the moieties with such groups.

In one embodiment, the R group of general formula (I) is an aliphatic hydrocarbon comprising conjugated double and/or triple bonds. Preferably, such conjugation is in the form of an yne-yne, ene-ene, yne-yne-yne, yne-yne-ene-, ene-yne-yne or yne-ene-yne moiety.

As used herein, the term “alkyl”, used either alone or in compound words denotes straight chain, branched or cyclic alkyl, for example C₁₋₄₀ alkyl, or C₁₋₂₀ or C₁₋₁₀, Examples of straight chain and branched alkyl include methyl, ethyl, n-propyl, isopropyl, n-butyl, sec-butyl, t-butyl, n-pentyl, 1,2-dimethylpropyl, 1,1-dimethyl-propyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethyl-pentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1-2-pentylheptyl, tridecyl, tetradecyl, pentadecyl, hexadecyl, heptadecyl, octadecyl, nonoadecyl, eicosyl and the like. Examples of cyclic alkyl include mono- or polycyclic alkyl groups such as cyclopropyl, cyclobutyl, cyclopentyl, cyclohexyl, cycloheptyl, cyclooctyl, cyclononyl, cyclodecyl and the like. Where an alkyl group is referred to generally as “propyl”, butyl” etc, it will be understood that this can refer to any of straight, branched and cyclic isomers where appropriate. An alkyl group may be optionally substituted by one or more optional substituents as herein defined.

As used herein, term “alkenyl” denotes groups formed from straight chain, branched or cyclic hydrocarbon residues containing at least one carbon to carbon double bond including ethylenically mono-, di- or polyunsaturated alkyl or cycloalkyl groups as previously defined, for example C₂₋₄₀ alkenyl, or C₂₋₂₀ or C₂₋₁₀. Thus, alkenyl is intended to include propenyl, butylenyl, pentenyl, hexaenyl, heptaenyl, octaenyl, nonaenyl, decenyl, undecenyl, dodecenyl, tridecenyl, tetradecenyl, pentadecenyl, hexadecenyl, heptadecenyl, octadecenyl, nondecenyl, eicosenyl hydrocarbon groups with one or more carbon to carbon double bonds. Examples of alkenyl include vinyl, allyl, 1-methylvinyl, butenyl, iso-butenyl, 3-methyl-2-butenyl, 1-pentenyl, cyclopentenyl, 1-methyl-cyclopentenyl, 1-hexenyl, 3-hexenyl, cyclohexenyl, 1-heptenyl, 3-heptenyl, 1-octenyl, cyclooctenyl, 1-nonenyl, 2-nonenyl, 3-nonenyl, 1-decenyl, 3-decenyl, 1,3-butadienyl, 1,4-p entadienyl, 1,3-cyclopentadienyl, 1,3-hexadienyl, 1,4-hex adienyl, 1,3-cyclohexadienyl, 1,4-cyclohexadienyl, 1,3-cycloheptadienyl, 1,3,5-cycloheptatrienyl and 1,3,5,7-cyclooctatetraenyl. An alkenyl group may be optionally substituted by one or more optional substituents as herein defined.

As used herein the term “alkynyl” denotes groups formed from straight chain, branched or cyclic hydrocarbon residues containing at least one carbon-carbon triple bond including ethylenically mono-, di- or polyunsaturated alkyl or cycloalkyl groups as previously defined, for example, C₂₋₄₀ alkenyl, or C₂₋₂₀ or C₂₋₁₀. Thus, alkynyl is intended to include propynyl, butylynyl, pentynyl, hexaynyl, heptaynyl, octaynyl, nonaynyl, decynyl, undecynyl, dodecynyl, tridecynyl, tetradecynyl, pentadecynyl, hexadecynyl, heptadecynyl, octadecynyl, nondecynyl, eicosynyl hydrocarbon groups with one or more carbon to carbon triple bonds. Examples of alkynyl include ethynyl, 1-propynyl, 2-propynyl, and butynyl isomers, and pentynyl isomers. An alkynyl group may be optionally substituted by one or more optional substituents as herein defined.

An alkenyl group may comprise a carbon to carbon triple bond and an alkynyl group may comprise a carbon to carbon double bond (i.e. so called ene-yne or yne-ene groups).

As used herein, the term “aryl” (or “carboaryl)” denotes any of single, polynuclear, conjugated and fused residues of aromatic hydrocarbon ring systems. Examples of aryl include phenyl, biphenyl, terphenyl, quaterphenyl, naphthyl, tetrahydronaphthyl, anthracenyl, dihydroanthracenyl, benzanthracenyl, dibenzanthracenyl, phenanthrenyl, fluorenyl, pyrenyl, idenyl, azulenyl, chrysenyl. Preferred aryl include phenyl and naphthyl. An aryl group may be optionally substituted by one or more optional substituents as herein defined.

As used herein, the terms “alkylene”, “alkenylene”, and “arylene” are intended to denote the divalent forms of “alkyl”, “alkenyl”, and “aryl”, respectively, as herein defined.

In this specification “optionally substituted” is taken to mean that a group may or may not be substituted or fused (so as to form a condensed polycyclic group) with one, two, three or more of organic and inorganic groups (i.e. the optional substituent) including those selected from: alkyl, alkenyl, alkynyl, carbocyclyl, aryl, heterocyclyl, heteroaryl, acyl, aralkyl, alkaryl, alkheterocyclyl, alkheteroaryl, alkcarbocyclyl, halo, haloalkyl, haloalkenyl, haloalkynyl, haloaryl, halocarbocyclyl, haloheterocyclyl, haloheteroaryl, haloacyl, haloaryalkyl, hydroxy, hydroxyalkyl, hydroxyalkenyl, hydroxyalkynyl, hydroxycarbocyclyl, hydroxyaryl, hydroxyheterocyclyl, hydroxyheteroaryl, hydroxyacyl, hydroxyaralkyl, alkoxyalkyl, alkoxyalkenyl, alkoxyalkynyl, alkoxycarbocyclyl, alkoxyaryl, alkoxyheterocyclyl, alkoxyheteroaryl, alkoxyacyl, alkoxyaralkyl, alkoxy, alkenyloxy, alkynyloxy, aryloxy, carbocyclyloxy, aralkyloxy, heteroaryloxy, heterocyclyloxy, acyloxy, haloalkoxy, haloalkenyloxy, haloalkynyloxy, haloaryloxy, halocarbocyclyloxy, haloaralkyloxy, haloheteroaryloxy, haloheterocyclyloxy, haloacyloxy, nitro, nitroalkyl, nitroalkenyl, nitroalkynyl, nitroaryl, nitroheterocyclyl, nitroheteroayl, nitrocarbocyclyl, nitroacyl, nitroaralkyl, amino (NH₂), alkylamino, dialkylamino, alkenylamino, alkynylamino, arylamino, diarylamino, aralkylamino, diaralkylamino, acylamino, diacylamino, heterocyclamino, heteroarylamino, carboxy, carboxyester, amido, alkylsulphonyloxy, arylsulphenyloxy, alkylsulphenyl, arylsulphenyl, thio, alkylthio, alkenylthio, alkynylthio, arylthio, aralkylthio, carbocyclylthio, heterocyclylthio, heteroarylthio, acylthio, sulfoxide, sulfonyl, sulfonamide, aminoalkyl, aminoalkenyl, amino alkynyl, amino carb ocyclyl, amino aryl, aminoheterocyclyl, aminohetero aryl, aminoacyl, aminoaralkyl, thioalkyl, thioalkenyl, thioalkynyl, thiocarbocyclyl, thioaryl, thioheterocyclyl, thioheteroaryl, thioacyl, thioaralkyl, carboxyalkyl, carboxyalkenyl, carboxyalkynyl, carboxycarbocyclyl, carboxyaryl, carboxyheterocyclyl, carboxyheteroaryl, carboxyacyl, carboxyaralkyl, carboxyesteralkyl, carboxyesteralkenyl, carboxyesteralkynyl, carboxyestercarbocyclyl, carboxyesteraryl, carboxyesterheterocyclyl, carboxyesterheteroaryl, carboxyesteracyl, carboxyesteraralkyl, amidoalkyl, amidoalkenyl, amidoalkynyl, amidocarbocyclyl, amido aryl, amidoheterocyclyl, amidohetero aryl, amidoacyl, amidoaralkyl, formylalkyl, formylalkenyl, formylalkynyl, formylcarbocyclyl, formylaryl, formylheterocyclyl, formylheteroaryl, formylacyl, formylaralkyl, acylalkyl, acylalkenyl, acylalkynyl, acylcarbocyclyl, acylaryl, acylheterocyclyl, acylheteroaryl, acylacyl, acylaralkyl, sulfoxidealkyl, sulfoxidealkenyl, sulfoxidealkynyl, sulfoxidecarbocyclyl, sulfoxidearyl, sulfoxideheterocyclyl, sulfoxideheteroaryl, sulfoxideacyl, sulfoxidearalkyl, sulfonylalkyl, sulfonylalkenyl, sulfonylalkynyl, sulfonylcarbocyclyl, sulfonylaryl, sulfonylheterocyclyl, sulfonylheteroaryl, sulfonylacyl, sulfonylaralkyl, sulfonamidoalkyl, sulfonamidoalkenyl, sulfonamidoalkynyl, sulfonamidocarbocyclyl, sulfonamido aryl, sulfonamidoheterocyclyl, sulfonamidoheteroaryl, sulfonamidoacyl, sulfonamidoaralkyl, nitroalkyl, nitroalkenyl, nitroalkynyl, nitrocarbocyclyl, nitroaryl, nitroheterocyclyl, nitroheteroaryl, nitroacyl, nitroaralkyl, cyano, sulfate and phosphate groups.

In some embodiments, it may be desirable that a group is optionally substituted with a reactive functional group or moiety. Examples of such reactive functional groups or moieties include epoxy, anhydride, cyclic ester (e.g. lactone or higher cyclic oligoester), cyclic amide (e.g. lactam or higher cyclic oligoamide), oxazoline and carbodimide.

In some embodiments, it may be desirable that a group is optionally substituted with a polymer chain. An example of such a polymer chain includes a polyether chain.

Preferred optional substituents include the aforementioned reactive functional groups or moieties, polymer chains and alkyl, (e.g. C₁₋₆ alkyl such as methyl, ethyl, propyl, butyl, cyclopropyl, cyclobutyl, cyclopentyl or cyclohexyl), hydroxyalkyl (e.g. hydroxymethyl, hydroxyethyl, hydroxypropyl), alkoxyalkyl (e.g. methoxymethyl, methoxyethyl, methoxypropyl, ethoxymethyl, ethoxyethyl, ethoxypropyl etc) alkoxy (e.g. C₁₋₆ alkoxy such as methoxy, ethoxy, propoxy, butoxy, cyclopropoxy, cyclobutoxy), halo, trifluoromethyl, trifluoromethyl, tribromomethyl, hydroxy, phenyl (which itself may be further substituted e.g., by C₁₋₆ alkyl, halo, hydroxy, hydroxyC₁₋₆ alkyl, C₁₋₆ alkoxy, haloC₁₋₆alkyl, cyano, nitro OC(O)C₁₋₆ alkyl, and amino), benzyl (wherein benzyl itself may be further substituted e.g., by C₁₋₆ alkyl, halo, hydroxy, hydroxyC₁₋₆alkyl, C₁₋₆ alkoxy, haloC₁₋₆ alkyl, cyano, nitro OC(O)C₁₋₆ alkyl, and amino), phenoxy (wherein phenyl itself may be further substituted e.g., by C₁₋₆ alkyl, halo, hydroxy, hydroxyC₁₋₆ alkyl, C₁₋₆ alkoxy, haloC₁₋₆ alkyl, cyano, nitro OC(O)C₁₋₆ alkyl, and amino), benzyloxy (wherein benzyl itself may be further substituted e.g., by C₁₋₆ alkyl, halo, hydroxy, hydroxyC₁₋₆ alkyl, C₁₋₆ alkoxy, haloC₁₋₆ alkyl, cyano, nitro OC(O)C₁₋₆ alkyl, and amino), amino, alkylamino (e.g. C₁₋₆ alkyl, such as methylamino, ethylamino, propylamino etc), dialkylamino (e.g. C₁₋₆ alkyl, such as dimethylamino, diethylamino, dipropylamino), acylamino (e.g. NHC(O)CH₃), phenylamino (wherein phenyl itself may be further substituted e.g., by C₁₋₆ alkyl, halo, hydroxy hydroxyC₁₋₆ alkyl, C₁₋₆ alkoxy, haloC₁₋₆ alkyl, cyano, nitro OC(O)C₁₋₆ alkyl, and amino), nitro, formyl, —C(O)-alkyl (e.g. C₁₋₆ alkyl, such as acetyl), O—C(O)-alkyl (e.g. C₁₋₆alkyl, such as acetyloxy), benzoyl (wherein the phenyl group itself may be further substituted e.g., by C₁₋₆ alkyl, halo, hydroxy hydroxyC₁₋₆ alkyl, C₁₋₆ alkoxy, haloC₁₋₆ alkyl, cyano, nitro OC(O)C₁₋₆alkyl, and amino), replacement of CH₂ with C═O, CO₂H, CO₂alkyl (e.g. C₁₋₆ alkyl such as methyl ester, ethyl ester, propyl ester, butyl ester), CO₂-phenyl (wherein phenyl itself may be further substituted e.g., by C₁₋₆ alkyl, halo, hydroxy, hydroxyl C₁₋₆ alkyl, C₁₋₆ alkoxy, halo C₁₋₆ alkyl, cyano, nitro OC(O)C₁₋₆ alkyl, and amino), CONH₂, CONHphenyl (wherein phenyl itself may be further substituted e.g., by C₁₋₆ alkyl, halo, hydroxy, hydroxyl C₁₋₆ alkyl, C₁₋₆ alkoxy, halo C₁₋₆ alkyl, cyano, nitro OC(O)C₁₋₆ alkyl, and amino), CONHbenzyl (wherein benzyl itself may be further substituted e.g., by C₁₋₆ alkyl, halo, hydroxy hydroxyl C₁₋₆ alkyl, C₁₋₆ alkoxy, halo C₁₋₆ alkyl, cyano, nitro OC(O)C₁₋₆ alkyl, and amino), CONHalkyl (e.g. C₁₋₆ alkyl such as methyl ester, ethyl ester, propyl ester, butyl amide) CONHdialkyl (e.g. C₁₋₆ alkyl)aminoalkyl (e.g., HN C₁₋₆ alkyl-, C₁₋₆alkylHN—C₁₋₆ alkyl- and (C₁₋₆ alkyl)₂N—C₁₋₆ alkyl-), thioalkyl (e.g., HS C₁₋₆ alkyl-), carboxyalkyl (e.g., HO₂CC₁₋₆ alkyl-), carboxyesteralkyl (e.g., C₁₋₆ alkylO₂CC₁₋₆ alkyl-), amidoalkyl (e.g., H₂N(O)CC₁₋₆ alkyl-, H(C₁₋₆ alkyl)N(O)CC₁₋₆ alkyl-), formylalkyl (e.g., OHCC₁₋₆alkyl-), acylalkyl (e.g., C₁₋₆ alkyl(O)CC₁₋₆ alkyl-), nitroalkyl (e.g., O₂NC₁₋₆ alkyl-), sulfoxidealkyl (e.g., R(O)SC₁₋₆ alkyl, such as C₁₋₆ alkyl(O)SC₁₋₆ alkyl-), sulfonylalkyl (e.g., R(O)₂SC₁₋₆ alkyl- such as C₁₋₆ alkyl(O)₂SC₁₋₆ alkyl-), sulfonamidoalkyl (e.g., ₂HRN(O)SC₁₋₆ alkyl, H(C₁₋₆alkyl)N(O)SC₁₋₆alkyl-).

In some embodiments, it may be preferable that the aliphatic hydrocarbon group R is optionally substituted with a polyether chain.

The term “halogen” (“halo”) denotes fluorine, chlorine, bromine or iodine (fluoro, chloro, bromo or iodo). Preferred halogens are chlorine, bromine or iodine.

The term “carbocyclyl” includes any of non-aromatic monocyclic, polycyclic, fused or conjugated hydrocarbon residues, preferably C₃₋₂₀ (e.g. C₃₋₁₀ or C₃₋₈). The rings may be saturated, e.g. cycloalkyl, or may possess one or more double bonds (cycloalkenyl) and/or one or more triple bonds (cycloalkynyl). Particularly preferred carbocyclyl moieties are 5-6-membered or 9-10 membered ring systems. Suitable examples include cyclopropyl, cyclobutyl, cyclopentyl, cyclohexyl, cycloheptyl; cyclooctyl, cyclononyl, cyclodecyl, cyclopentenyl, cyclohexenyl, cyclooctenyl, cyclopentadienyl, cyclohexadienyl, cyclooctatetraenyl, indanyl, decalinyl and indenyl.

The term “heterocyclyl” when used alone or in compound words includes any of monocyclic, polycyclic, fused or conjugated hydrocarbon residues, preferably C₃₋₂₀ (e.g. C₃₋₁₀ or C₃₋₈) wherein one or more carbon atoms are replaced by a heteroatom so as to provide a non-aromatic residue. Suitable heteroatoms include O, N, S, P and Se, particularly O, N and S. Where two or more carbon atoms are replaced, this may be by two or more of the same heteroatom or by different heteroatoms. The heterocyclyl group may be saturated or partially unsaturated, i.e. possess one or more double bonds. Particularly preferred heterocyclyl are 5-6 and 9-10 membered heterocyclyl. Suitable examples of heterocyclyl groups may include azridinyl, oxiranyl, thiiranyl, azetidinyl, oxetanyl, thietanyl, 2H-pyrrolyl, pyrrolidinyl, pyrrolinyl, piperidyl, piperazinyl, morpholinyl, indolinyl, imidazolidinyl, imidazolinyl, pyrazolidinyl, thiomorpholinyl, dioxanyl, tetrahydrofuranyl, tetrahydropyranyl, tetrahydropyrrolyl, tetrahydrothiophenyl, pyrazolinyl, dioxalanyl, thiazolidinyl, isoxazolidinyl, dihydropyranyl, oxazinyl, thiazinyl, thiomorpholinyl, oxathianyl, dithianyl, trioxanyl, thiadiazinyl, dithiazinyl, trithianyl, azepinyl, oxepinyl, thiepinyl, indenyl, indenyl, 3H-indolyl, isoindolinyl, 4H-quinolazinyl, chromenyl, chromanyl, isochromanyl, pyranyl and dihydropyranyl.

The term “heteroaryl” includes any of monocyclic, polycyclic, fused or conjugated hydrocarbon residues, wherein one or more carbon atoms are replaced by a heteroatom so as to provide an aromatic residue. Preferred heteroaryl have 3-20 ring atoms, e.g. 3-10. Particularly preferred heteroaryl are 5-6 and 9-10 membered bicyclic ring systems. Suitable heteroatoms include, O, N, S, P and Se, particularly O, N and S. Where two or more carbon atoms are replaced, this may be by two or more of the same heteroatom or by different heteroatoms. Suitable examples of heteroaryl groups may include pyridyl, pyrrolyl, thienyl, imidazolyl, furanyl, benzothienyl, isobenzothienyl, benzofuranyl, isobenzofuranyl, indolyl, isoindolyl, pyrazolyl, pyrazinyl, pyrimidinyl, pyridazinyl, indolizinyl, quinolyl, isoquinolyl, phthalazinyl, 1,5-naphthyridinyl, quinozalinyl, quinazolinyl, quinolinyl, oxazolyl, thiazolyl, isothiazolyl, isoxazolyl, triazolyl, oxadialzolyl, oxatriazolyl, triazinyl, and furazanyl.

The term “acyl” either alone or in compound words denotes a group containing the moiety C═O (and not being a carboxylic acid, ester or amide) Preferred acyl includes C(O)—R^{x}, wherein R^{x} is hydrogen or an alkyl, alkenyl, alkynyl, aryl, heteroaryl, carbocyclyl, or heterocyclyl residue. Examples of acyl include formyl, straight chain or branched alkanoyl (e.g. C₁₋₂₀) such as, acetyl, propanoyl, butanoyl, 2-methylpropanoyl, pentanoyl, 2,2-dimethylpropanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl, octadecanoyl, nonadecanoyl and icosanoyl; cycloalkylcarbonyl such as cyclopropylcarbonyl cyclobutylcarbonyl, cyclopentylcarbonyl and cyclohexylcarbonyl; aroyl such as benzoyl, toluoyl and naphthoyl; aralkanoyl such as phenylalkanoyl (e.g. phenylacetyl, phenylpropanoyl, phenylbutanoyl, phenylisobutylyl, phenylpentanoyl and phenylhexanoyl) and naphthylalkanoyl (e.g. naphthylacetyl, naphthylpropanoyl and naphthylbutanoyl]; aralkenoyl such as phenylalkenoyl (e.g. phenylpropenoyl, phenylbutenoyl, phenylmethacryloyl, phenylpentenoyl and phenylhexenoyl and naphthylalkenoyl (e.g. naphthylpropenoyl, naphthylbutenoyl and naphthylpentenoyl); aryloxyalkanoyl such as phenoxyacetyl and phenoxypropionyl; arylthiocarbamoyl such as phenylthiocarbamoyl; arylglyoxyloyl such as phenylglyoxyloyl and naphthylglyoxyloyl; arylsulfonyl such as phenylsulfonyl and napthylsulfonyl; heterocycliccarbonyl; heterocyclicalkanoyl such as thienylacetyl, thienylpropanoyl, thienylbutanoyl, thienylpentanoyl, thienylhexanoyl, thiazolylacetyl, thiadiazolylacetyl and tetrazolylacetyl; heterocyclicalkenoyl such as heterocyclicpropenoyl, heterocyclicbutenoyl, heterocyclicpentenoyl and heterocyclichexenoyl; and heterocyclicglyoxyloyl such as thiazolyglyoxyloyl and thienylglyoxyloyl. The R^{x} residue may be optionally substituted as described herein.

The term “sulfoxide”, either alone or in a compound word, refers to a group —S(O)R^{y} wherein R^{y} is selected from hydrogen, alkyl, alkenyl, alkynyl, aryl, heteroaryl, heterocyclyl, carbocyclyl, and aralkyl. Examples of preferred R^{y} include C₁₋₂₀alkyl, phenyl and benzyl.

The term “sulfonyl”, either alone or in a compound word, refers to a group S(O)₂—R^{y}, wherein R^{y} is selected from hydrogen, alkyl, alkenyl, alkynyl, aryl, heteroaryl, heterocyclyl, carbocyclyl and aralkyl. Examples of preferred R^{y} include C₁₋₂₀alkyl, phenyl and benzyl.

The term “sulfonamide”, either alone or in a compound word, refers to a group S(O)NR^{y}R^{y} wherein each R^{y} is independently selected from hydrogen, alkyl, alkenyl, alkynyl, aryl, heteroaryl, heterocyclyl, carbocyclyl, and aralkyl. Examples of preferred R^{y} include C₁₋₂₀alkyl, phenyl and benzyl. In a preferred embodiment at least one R^{y} is hydrogen. In another form, both R^{y} are hydrogen.

The term, “amino” is used here in its broadest sense as understood in the art and includes groups of the formula NR^{A}R^{B} wherein R^{A} and R^{B} may be any independently selected from hydrogen, alkyl, alkenyl, alkynyl, aryl, carbocyclyl, heteroaryl, heterocyclyl, aralkyl, and acyl. R^{A} and R^{B}, together with the nitrogen to which they are attached, may also form a monocyclic, or polycyclic ring system e.g. a 3-10 membered ring, particularly, 5-6 and 9-10 membered systems. Examples of “amino” include NH₂, NHalkyl (e.g. C₁₋₂₀alkyl), NHaryl (e.g. NHphenyl), NHaralkyl (e.g. NHbenzyl), NHacyl (e.g. NHC(O)C₁₋₂₀alkyl, NHC(O)phenyl), Nalkylalkyl (wherein each alkyl, for example C₁₋₂₀, may be the same or different) and 5 or 6 membered rings, optionally containing one or more same or different heteroatoms (e.g. O, N and S).

The term “amido” is used here in its broadest sense as understood in the art and includes groups having the formula C(O)NR^{A}R^{B}, wherein R^{A} and R^{B} are as defined as above. Examples of amido include C(O)NH₂, C(O)NHalkyl (e.g. C₁₋₂₀alkyl), C(O)NHaryl (e.g. C(O)NHphenyl), C(O)NHaralkyl (e.g. C(O)NHbenzyl), C(O)NHacyl (e.g. C(O)NHC(O)C₁₋₂₀alkyl, C(O)NHC(O)phenyl), C(O)Nalkylalkyl (wherein each alkyl, for example C₁₋₂₀, may be the same or different) and 5 or 6 membered rings, optionally containing one or more same or different heteroatoms (e.g. O, N and S).

The term “carboxy ester” is used here in its broadest sense as understood in the art and includes groups having the formula CO₂R^{z}, wherein R^{z} may be selected from groups including alkyl, alkenyl, alkynyl, aryl, carbocyclyl, heteroaryl, heterocyclyl, aralkyl, and acyl. Examples of carboxy ester include CO₂C₁₋₂₀alkyl, CO₂aryl (e.g. CO₂-phenyl), CO₂aralkyl (e.g. CO₂ benzyl).

The term “heteroatom” or “hetero” as used herein in its broadest sense refers to any atom other than a carbon atom which may be a member of a cyclic organic group. Particular examples of heteroatoms include nitrogen, oxygen, sulfur, phosphorous, boron, silicon, selenium and tellurium, more particularly nitrogen, oxygen and sulfur.

Polyurethanes in accordance with the invention may comprise the α-oxy carbonyl moiety when present in a portion of the polymer backbone represented by general formula (II):

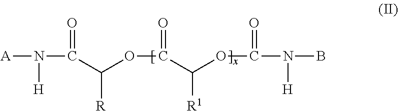

A, B and R in general formula (II) are as hereinbefore defined. R¹ is an optionally substituted aliphatic hydrocarbon, and x may be 0 or is a positive integer ranging form 1 to 100, for example 1 to 50 or 1 to 25. R¹ will generally be an aliphatic hydrocarbon having 1 to 40 carbon atoms, for example 1 to 20 carbon atoms. R¹ may be linear or branched, saturated or unsaturated. Where the hydrocarbon R¹ is unsaturated, it may be mono- or poly-unsaturated, and includes both cis- and trans-isomers. The hydrocarbon R¹ may be a linear or branched alkyl, alkenyl, or alkynyl group. R¹ may also be an acyclic hydrocarbon (i.e. a non-cyclic hydrocarbon). Accordingly, R¹ may be the same or different from R. The hydrocarbon R¹ may be substituted, for example with a hetero atom containing moiety and/or an aromatic or cyclic moiety. In some embodiments the R¹ group is not substituted. Where x in formula (II) is a positive integer, those skilled in the art will appreciate that the —[—C(O)—CH(R¹)—O—]— moiety represents an ester chain extender or polyester polyol within the polymer backbone. Where x≧2 each R¹ may be the same or different.

Within the polymer backbone of the polyurethanes in accordance with the invention it will be appreciated that the structure of general formula (II) provides for an amide and a urethane linkage.

Polyurethanes in accordance with the invention may comprise the α-oxy carbonyl moiety in a portion of the polymer backbone represented by general formula (III):

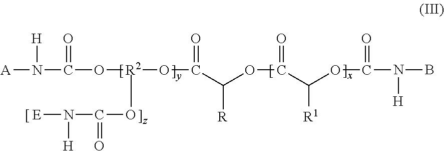

A, B, R, R¹ and x in general formula (III) are as hereinbefore defined. E (when present) represents with A and B the remainder of the polymer backbone, R² is a z+2 valent moiety selected from optionally substituted alkylene, optionally substituted alkenylene, optionally substituted arylene, and optionally substituted alkylene-arylene-alkylene, y is a positive integer ranging from 1 to 100, for example 1 to 50, or 1 to 25, wherein for each repeat unit y when y≧2, R² is the same or different, and z is 0 or an integer ranging from 1 to 20, for example 1 to 10, or 1 to 5. In some embodiments of the invention, y ranges from 1 to 5 and z is 0. Generally, R² is a z+2 valent moiety selected from optionally substituted C₁-C₁₂ alkylene, optionally substituted C₂-C₁₂ alkenylene, optionally substituted C₆-C₁₈ arylene, and optionally substituted C₂-C₁₂ alkylene-C₆-C₁₈ arylene-C₂-C₁₂ alkylene.

Those skilled in the art will appreciate that the —[—R²—O—]— moiety in general formula (III) represents an ether chain extender or polyether polyol within the polymer backbone. This moiety may itself comprise a branch point within the polymer backbone represented by —(OC(O)NHE)_{z}, where z may be 0 (i.e. no branch point present) or an integer ranging from 1 to 20 (i.e. branch point present). In contrast with y, the integer z is therefore not intended to represent a repeat unit per se, but rather to reflect the valency of the R² moiety. For example where y is 1 and z is 1, the R² moiety will have a valency of 3 (i.e. z+2) and the ANHC(O)O—[—R²—(OC(O)NHE)_{z}-O—]— moiety in general formula (III) may, for example, be represented by moiety (a):

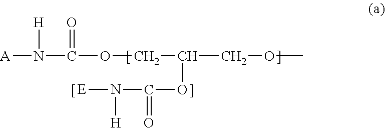

R² is defined as a z+2 valent moiety selected from optionally substituted alkylene, optionally substituted alkenylene, optionally substituted arylene, and optionally substituted alkylene-arylene-alkylene. Thus, when z is 0, R² is simply selected from optionally substituted alkylene, optionally substituted alkenylene, optionally substituted arylene, and optionally substituted alkylene-arylene-alkylene. When z is an integer ranging from 1 to 20, the R² moiety provides for a branch point within the polymer backbone and therefore will be at least tri-valent. For example, R² in moiety (a) above (where z is 1) may be described as a tri-valent alkylene group. The expression “z+2 valent” is therefore intended to operate on the “optionally substituted alkylene” etc language as appropriate.

When z is an integer ranging from 1 to 20, it will be appreciated that E represents a branch polymer chain and forms together with A and B the remainder of the polymer backbone.

In some embodiments, z is 0.

The portion of the polymer backbone represented by general formula (III) in the polyurethanes in accordance with the invention can be seen to provide for at least two urethane linkages.

The polyurethanes in accordance with the invention may, and preferably will, comprise multiple portions represented by general formulae (II) and/or (III) within their polymer backbone.

Those skilled in the art will appreciate that ester linkages within polyurethanes according to the invention may be prone to transesterification, thereby having the practical effect of relocating an α-oxy carbonyl moiety within the polymer chain. Such transesterified structures are also intended to fall within the scope of the present invention. For example, general formula (II) may be redrawn as general formula (IIa):

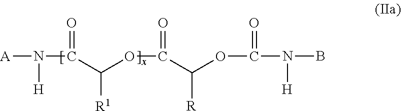

Similarly, general formula (III) may be redrawn as general formula (IIIa):

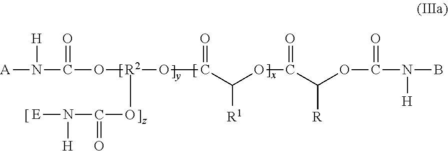

In addition to the chain extender and polyol moieties discussed above in the context of general formulae (II) and (III), the remainder of the polyurethane in accordance with the invention (i.e. represented by A and B (and optionally E) in these formulae) may of course comprise other chain extenders and/or polyols. Such chain extenders and polyols will of course include those having a functionality of three or more in order to introduce crosslinking and/or branching into the polyurethanes.

Reagents, equipment, and conditions for manufacturing polyurethanes are in general well known in the art. Polyurethanes in accordance with the invention can advantageously be prepared using similar reagents, equipment and conditions.

In accordance with the invention, the polyurethanes are prepared by forming a urethane linkage through reaction of a compound comprising an isocyanate functional group and a compound of general formula (IV):

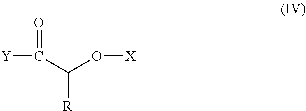

where Y is OH or —[—O—R²(OH)_{z}—]_{y}—OH, X is H or —[—C(O)CH(R¹)O—]ₓ—H, and R, R¹, R², x, y and z are as hereinbefore defined.

The method of preparing the polyurethanes will generally comprise reacting a polyisocyanate compound with a compound of general formula (IV).

Compounds falling within the scope of general formula (IV) may simply be represented as an α-hydroxy fatty acid of general formula (V):

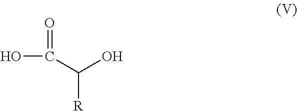

where R is as hereinbefore defined.

Through a condensation reaction process, those skilled in the art will appreciate that the reaction of an α-hydroxy fatty acid of general formula (V) with a compound selected from H—[—O—R²(OH)_{z}—]_{y}—OH and HO—[—C(O)CH(R¹)O—]ₓ—H, where R², y, z, and R¹ are as hereinbefore defined and x in this case is not 0, will give rise to other compounds falling within the scope of general formula (IV).

Alternatively, compounds falling within the scope of general formula (IV) may be prepared by reacting a polyol such as H—[—O—R²(OH)_{z}—]_{y}—OH, where R², y and z are as hereinbefore defined, with a cyclic ester having at least two ester moieties that form part of its cycle, wherein said cycle comprises an α-oxy carbonyl moiety of general formula (VI):

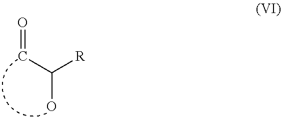

where R is as hereinbefore defined.

As used herein, a the expression “cyclic ester” is intended to mean a cyclic molecule having at least one ring (or cycle) within its molecular structure that contains an ester moiety that forms part of that cycle. In accordance with the invention, the cyclic ester has at least two ester moieties that form part of its cycle. Those skilled in the art will appreciate that such cyclic esters are commonly referred to as macrocyclic oligoesters.

As used herein the term “polyol” is a reference to a compound comprising two or more hydroxyl (—OH) groups. Examples of such compounds include those have the formula H—[—O—R²(OH)_{z}—]_{y}—OH, where R², y and z are as hereinbefore defined. More specific examples of polyols include ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, diethanolamine, methyldiethanolamine, phenyldiethanolamine, glycerol, trimethylolpropane, 1,2,6-hexanetriol, triethanolamine, (di)-(tri)-pentaerythritol, and N,N,N′,N′-tetrakis(2-hydroxypropyl)ethylenediamine.

Those skilled in the art will also appreciate that a convenient synthetic route to forming cyclic esters is through a condensation reaction of hydroxycarboxylic acids. As part of the cyclic ester used in accordance with the invention, the α-oxy carbonyl of general formula (VI) might therefore be conveniently described as a condensation residue of an α-hydroxycarboxylic acid of general formula (V).

The cyclic ester that may be used in accordance with the invention has at least two ester moieties that form part of its cycle. Those skilled in the art will appreciate that the carbonyl group of the α-oxy carbonyl moiety of general formula (VI) will in effect provide for one of these ester moieties, and the at least one other ester moiety will be provided by at least one other condensed moiety of a hydroxycarboxylic acid. This at least one further condensed hydroxycarboxylic acid residue may be the same or different to the α-oxy carbonyl moiety of general formula (VI), and will complete the cycle of the cyclic ester as represented by the dashed lines in general formula (VI).

Thus, a cyclic ester suitable for use in accordance with the invention might have a cyclic structure that is formed from the condensed moieties of at least two α-hydroxycarboxylic acids of general formula (V), or one or more α-hydroxycarboxylic acids of general formula (V) and one or more other hydroxycarboxylic acids. The general structure of a cyclic ester of this type may be conveniently represented by general formula (VII):

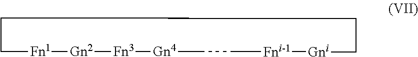

where F is a condensation residue of an α-hydroxycarboxylic acid of general structure (V), G is the condensation residue of a hydroxycarboxylic acid, each F and each G may be the same or different, each n may be 0 or a positive integer, and i is a positive integer of the series 1, 2, 3, . . . i, wherein n¹≧1 and n¹+n²≧2.

The cyclic ester of general formula (VII) can therefore be seen to represent a macrocyclic oligoester.

Those skilled in the art will appreciate that the cyclic ester of general formula (VII) serves merely to illustrate the variety of cyclic structures that may be formed in the preparation of cyclic esters. In other words, the cycle size of a cyclic ester may vary depending upon how the cyclic ester is made and from what hydroxycarboxylic acid it is made from. A cyclic ester might also comprise a mixture of different cycle compositions and cycle sizes.

A cyclic esters that may be used in accordance with the invention requires at least two ester moieties that form part of its cycle. The ester moieties will generally be joined with in the cycle by one or more carbon atoms. There is no particular limitation to the number of ester moieties that may form part of the cycle, but there will generally be no more than about six of such moieties. Accordingly, the cyclic ester might be a dilactone, trilactone, tetralactone, pentalactone, hexylactone, or mixture thereof.

In view of the complexities associated with defining the specific composition of a cyclic ester, it can often be more convenient to refer to the cyclic ester in terms of it being formed from the condensed residue(s) of a particular hydroxycarboxylic acid(s).

Thus, a cyclic ester that may be used in accordance with the invention might be described as comprising as part of its cycle the condensed residue of at least one α-hydroxycarboxylic acid of general formula (V).

A cyclic ester that may be used in accordance with the invention might also be described as comprising as part of its cycle the condensed residue of at least one α-hydroxycarboxylic acid of general formula (V) and at least one other hydroxycarboxylic acid.

A cyclic ester that may be used in accordance with the invention might also be described as comprising as part of its cycle the condensed residue of at least one α-hydroxycarboxylic acid of general formula (V) and at least one α-hydroxycarboxylic acid of general formula (VIII):

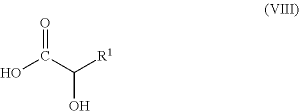

where R¹ is as herein before defined.

When preparing cyclic esters, compounds of general formula (V) will generally undergo condensation reactions with itself or other hydroxycarboxylic acids to at least form a dilactone.

Thus, in one embodiment the cyclic ester used comprises a dilactone formed through the condensation of an α-hydroxycarboxylic acid of a general formula (V).

In a further embodiment, the cyclic ester used comprises a dilactone formed through the condensation of an α-hydroxycarboxylic acid of general formula (V) and another hydroxycarboxylic acid.

In another embodiment, the cyclic ester used comprises a dilactone formed through the condensation of an α-hydroxycarboxylic acid of general formula (V) and an α-hydroxycarboxylic acid of general formula (VIII). In that case, the cyclic ester used will comprises a dilactone of general formula (IX):

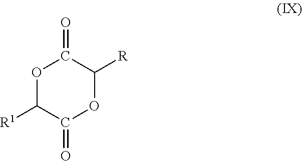

where R and R¹ are the same or different and are as hereinbefore defined.

Where the cyclic ester used comprises an optionally substituted aliphatic hydrocarbon R¹, R¹ will generally be an aliphatic hydrocarbon having 1 to 40, for example 1 to 20 carbon atoms. R¹ may be linear or branched, saturated or unsaturated. Where the hydrocarbon is unsaturated, it may be mono- or poly-unsaturated, and includes both cis- and trans-isomers. The hydrocarbon group R¹ may be a linear or branched alkyl, alkenyl, or alkynyl group. R¹ may also be an acyclic hydrocarbon (i.e. a non-cyclic hydrocarbon). Accordingly, R¹ may be the same or different from R. The hydrocarbon R¹ may be substituted, for example with a hetero atom containing moiety and/or an aromatic or cyclic moiety. In some embodiments the R¹ group is not substituted.

Reagents, equipment, and conditions for manufacturing cyclic esters through the cyclic condensation of hydroxycarboxylic acids are generally well known in the art. Cyclic esters suitable for use in accordance with the invention can advantageously be prepared in a similar manner.

For example, cyclic esters can be prepared by subjecting an α-hydroxycarboxylic acid of general formula (V), optionally together with one or more different hydroxycarboxylic acids, to heat under vacuum, or by using several methods described in the literature. (Journal of Biomedical Materials Research Part A, Volume 80A, Issue 1, pp 55-65, Polymer Preprints 2005, 46 (2), 1040, Polymer Preprints 2005 (46 (2), 1006).

Cyclic esters suitable for use in accordance with the invention may be conveniently prepared using a variety of α-hydroxycarboxylic fatty acids of general formula (V). Examples of α-hydroxycarboxylic acids of general formula (V) include α-hydroxy valeric acid, α-hydroxy caproic acid, α-hydroxy caprylic acid, α-hydroxy pelargonic acid, α-hydroxy capric acid, α-hydroxy lauric acid, α-hydroxy mytistic acid, α-hydroxy palmitic acid, α-hydroxy margaric acid, α-hydroxy stearic acid, α-hydroxy arachidic acid, α-hydroxy behenic acid, α-hydroxy lignoceric acid, α-hydroxy cerotic acid, α-hydroxy carboceric acid, α-hydroxy montanic acid, α-hydroxy melissic acid, α-hydroxy lacceroic acid, α-hydroxy ceromelissic acid, α-hydroxy geddic acid, α-hydroxy ceroplastic acid, α-hydroxy obtusilic acid, α-hydroxy caproleic acid, α-hydroxy lauroleic acid, α-hydroxy linderic acid, α-hydroxy myristoleic acid, α-hydroxy physeteric acid, α-hydroxy tsuzuic acid, α-hydroxy palmitoleic acid, α-hydroxy sapienic acid, α-hydroxy petroselinic acid, α-hydroxy oleic acid, α-hydroxy elaidic acid, α-hydroxy vaccenic acid, α-hydroxy gadoleic acid, α-hydroxy gondoic acid, α-hydroxy cetoleic acid, α-hydroxy erucic acid, α-hydroxy nervonic acid, α-hydroxy linoleic acid, α-hydroxy γ-linolenic acid, α-hydroxy dihomo-γ-linolenic acid, α-hydroxy arachidonic acid, α-hydroxy α-linolenic acid, α-hydroxy steridonic acid, α-hydroxy nisinic acid, and α-hydroxy Mead Acid.

Examples of hydroxycarboxylic acids that may undergo cyclic condensation with α-hydroxycarboxylic acids of general formula (V) to form cyclic esters suitable for use in accordance with the invention include glycolic acid, lactic acid, 2-hydroxybutanoic acid, 2-hydroxypentanoic acid, 3-hydroxypropanoic acid, 3-hydroxybutanoic acid, 3-hydroxypentanoic acid, 3-hydroxyhexanoic acid, 3-hydroxyheptanoic acid, 3-hydroxyoctanoic acid, 3-hydroxy-3-methylbutanoic acid, 3-hydroxy-3-methylheptanoic acid, 3-hydroxy-3-methylheptanoic acid, 3-hydroxy-3-ethylpentanoic acid, 3-hydroxy-3-methylhexanoic acid, 3-hydroxy-3-ethylhexanoic acid, 3-hydroxy-3-propylhexanoic acid, 3-hydroxy-3-methylheptanoic acid, 3-hydroxy-3-ethylheptanoic acid, 3-hydroxy-3-propylheptanoic acid, 3-hydroxy-3-butylheptanoic acid, 3-hydroxy-3-methyloctanoic acid, 3-hydroxy-3-ethyloctanoic acid, 3-hydroxy-3-propyloctanoic acid, 3-hydroxy-3-butyloctanoic acid, 3-hydroxy-3-pentyloctanoic acid, 4-hydroxybutanoic acid, 4-hydroxypentanoic acid, 4-hydroxyhexanoic acid, 4-hydroxyheptanoic acid, 4-hydroxyoctanoic acid, 4-hydroxy-4-methylpentanoic acid, 4-hydroxy-4-methylhexanoic acid, 4-hydroxy-4-ethylhexanoic acid, 4-hydroxy-4-methylheptanoic acid, 4-hydroxy-4-ethylheptanoic acid, 4-hydroxy-4-propylheptanoic acid, 4-hydroxy-4-methyloctanoic acid, 4-hydroxy-4-ethyloctanoic acid, 4-hydroxy-4-propyloctanoic acid, 4-hydroxy-4-butyloctanoic acid, 5-hydroxypentanoic acid, 5-hydroxyhexanoic acid, 5-hydroxyheptanoic acid, 5-hydroxyoctanoic acid, 5-hydroxy-5-methylhexanoic acid, 5-hydroxy-5-methylheptanoic acid, 5-hydroxy-5-ethylheptanoic acid, 5-hydroxy-5-methyloctanoic acid, 5-hydroxy-5-ethyloctanoic acid, 5-hydroxy-5-propyloctanoic acid, 6-hydroxyhexanoic acid, 6-hydroxyheptanoic acid, 6-hydroxyoctanoic acid, 6-hydroxy-6-methylheptanoic acid, 6-hydroxy-6-methyloctanoic acid, 6-hydroxy-6-ethyloctanoic acid, 7-hydroxyheptanoic acid, 7-hydroxyoctanoic acid, 7-hydroxy-7-methyloctanoic acid, 8-hydroxyoctanoic acid, and other aliphatic hydroxycarboxylic acids. These acids can be used singly or as a mixture.

Where a compound of formula (IV) is prepared by reacting a polyol with a cyclic ester, the resulting compound may be represented by formula (X):

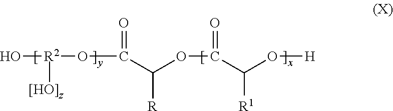

where R, R¹, R², y and z are as herein defined and x is an integer ranging from 1 to 10, for example 1 to 5 or 1 to 3. In one embodiment x is 1. In a further embodiment, x is 1, y ranges from 1 to 5 and z is 0.

Compounds of general formula (IV) can be prepared by condensation and/or ring opening reactions either carried out neat, in the melt, or with the addition of an appropriate solvent. Such reactions might also be enhanced through the addition of a condensation/transesterification catalyst (e.g. dibutyltindilaurate, p-toluene sulphonic acid etc).

The α-oxy carbonyl moiety in the general formula presented herein may conveniently be described as being a residue of an α-hydroxy fatty acid. There is no particular limitation concerning the range of α-hydroxy fatty acids from which the α-oxy carbonyl moiety may be derived provided that the R group is an optionally substituted aliphatic hydrocarbon having three or more carbon atoms.

Examples of suitable α-hydroxy fatty acids include, but are not limited to α-hydroxy valeric acid, α-hydroxy caproic acid, α-hydroxy caprylic acid, α-hydroxy pelargonic acid, α-hydroxy capric acid, α-hydroxy lauric acid, α-hydroxy mytistic acid, α-hydroxy palmitic acid, α-hydroxy margaric acid, α-hydroxy stearic acid, α-hydroxy arachidic acid, α-hydroxy behenic acid, α-hydroxy lignoceric acid, α-hydroxy cerotic acid, α-hydroxy carboceric acid, α-hydroxy montanic acid, α-hydroxy melissic acid, α-hydroxy lacceroic acid, α-hydroxy ceromelissic acid, α-hydroxy geddic acid, α-hydroxy ceroplastic acid, α-hydroxy obtusilic acid, α-hydroxy caproleic acid, α-hydroxy lauroleic acid, α-hydroxy linderic acid, α-hydroxy myristoleic acid, α-hydroxy physeteric acid, α-hydroxy tsuzuic acid, α-hydroxy palmitoleic acid, α-hydroxy sapienic acid, α-hydroxy petroselinic acid, α-hydroxy oleic acid, α-hydroxy elaidic acid, α-hydroxy vaccenic acid, α-hydroxy gadoleic acid, α-hydroxy gondoic acid, α-hydroxy cetoleic acid, α-hydroxy erucic acid, α-hydroxy nervonic acid, α-hydroxy linoleic acid, α-hydroxy γ-linolenic acid, α-hydroxy dihomo-γ-linolenic acid, α-hydroxy arachidonic acid, α-hydroxy α-linolenic acid, α-hydroxy steridonic acid, α-hydroxy nisinic acid, and α-hydroxy Mead Acid.

Providing the aliphatic hydrocarbon group R and/or R¹ with one or more reactive functional groups can advantageously enable organic or inorganic moieties to be tethered to the polymer backbone through reaction of the moieties with such groups. The organic or inorganic moieties may be conveniently tethered to the R and/or R¹ group of a compound of general formula (IV) prior to preparing the polyurethane, or tethered to the R and/or R¹ group after preparing the polyurethane.

To prepare polyurethanes in accordance with the invention, a urethane linkage is formed through reaction of a compound comprising an isocyanate functional group and a compound of general formula (IV). The isocyanate functional group will typically form part of a polyisocyanate (i.e. a compound having two or more isocyanate functional groups).

Polyisocyanates used in the manufacture of conventional polyurethanes are well known in the art. Such polyisocyanates can advantageously be used in preparing polyurethanes in accordance with the present invention.

Suitable polyisocyanates include aliphatic, aromatic and cycloaliphatic polyisocyanates and combinations thereof. Useful isocyanates include, but are not limited to, diisocyanates such as m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,3-cyclohexane diisocyanate, 1,4-cyclohexane diisocyanate, hexahydro-toluene diisocyanate and its isomers, isophorone diisocyanate, dicyclo-hexylmethane diisocyanates, 1,5-napthylene diisocyanate, 4,4′-diphenylmethane diisocyanate, 2,4′ diphenylmethane diisocyanate, 4,4′-biphenylene diisocyanate, 3,3′-dimethoxy-4,4′-biphenylene diisocyanate, and 3,3′-dimethyl-diphenylpropane-4,4′-diisocyanate; triisocyanates such as 2,4,6-toluene triisocyanate; polyisocyanates such as 4,4′-dimethyl-diphenylmethane-2,2′,5,5′-tetraisocyanate and polymethylene polyphenylpolyisocyanates; and combinations thereof.

The polyurethanes might be prepared batch wise by mixing all components together and waiting until an exotherm occurs followed by casting the mixture into a container. The mixture can be subsequently heated to drive the reaction. When adopting this approach, the components to be mixed might first be made up into two parts before mixing: Part-1 might include a compound of general formula (IV) and one or more of: a polyol, a chain extender, blowing agent (e.g. water), catalyst, and surfactants etc. Part-2 will generally comprise the polyisocyanate. Part-1 or Part-2 can also contain other additives such as fillers, pigments etc.

The polyurethanes might also be prepared as a prepolymer that is subsequently reacted with a chain extender. For example, through suitable adjustment of molar ratios, an isocyanate terminated pre-polymer may be prepared by mixing Parts-1 and -2 mentioned above. The isocyanate terminated polymer could then be reacted with a chain extender/branching molecule such as a short chain diol (e.g. 1-4 butanediol). Alternatively, through suitable adjustment of molar ratios, the prepolymer could be produced such that it was hydroxy terminated. This hydroxy terminated prepolymer could then be reacted with a polyisocyanate to produce the desired polyurethane.

The polyurethane forming reactions can be carried out in a range of different equipment including batch kettles, static mixers, reactive injection moulders or extruders.

It also may be advantageous to heat the reagents prior to or during the reaction process to improve their solubility or to enhance their reactivity. The reaction process may also be conducted in solvent.

When selecting a compound of general formula (IV) for use in preparing the polyurethanes in accordance with the invention, those skilled in the art will appreciate that the nature of any substituents of the R group will need to be considered in terms of their potential to react (either advantageously or adversely) with the polyisocyanate.

For illustrative purposes only, a polyurethane in accordance with the invention may comprise the reaction product of a compound of general formula (IV) where Y is —[—O—R²(OH)_{z}—]_{y}—OH with z=0 and X is H and a di-isocyanate compound represented by OCN—Z—NCO, where Z represents the remainder of the di-isocyanate compound. In that case, the polyurethane is expected to comprise a repeat unit of general formula (XI):

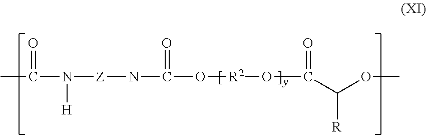

where Z, R, R² and y are as hereinbefore defined.

Similarly, a polyurethane in accordance with the invention may comprise the reaction product of general formula (V) and the di-isocyanate represented by OCN—Z—NCO. In that case, the polyurethane is expected to comprise a repeat unit of general formula (XII):

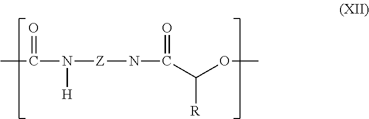

where Z and R are as hereinbefore defined.

In addition to forming polyurethanes in accordance with the invention through reaction of a polyisocyanate and a compound of general formula (IV) as outlined above, conventional chain extenders and polyols may also be included in the reaction process. Examples of such materials include, but are not limited to ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, neopentyl glycol, 1,6-hexanediol, 1,4-cyclohexanedimethanol, ethanolamine, diethanolamine, methyldiethanolamine, phenyldiethanolamine, glycerol, trimethylolpropane, 1,2,6-hexanetriol, triethanolamine, pentaerythritol, N,N,N′,N-tetrakis(2-hydroxypropyl)ethylenediamine, diethyltoluenediamine and dimethylthiotoluenediamine.

When preparing the polyurethanes in accordance with the invention, it may also be necessary to include a catalyst such as an amine compound or organometallic compound. Typical amine catalysts include, but are not limited to tertiary amines such as triethylenediamine, dimethylcyclohexylamine, and dimethylethanolamine. Organometallic compounds include those based on mercury, lead, tin, bismuth and zinc. Specific examples of these compounds include are not limited to dibuytlene dilaurate, bismuth octanoate, and phenylmercuric neodeconate.

Conventional additives such as surfactants may also be used in preparing the polyurethanes.

In some embodiments of the invention, it may be desirable when preparing the polyurethanes to keep the molar ratio of the polyisocyanate to compounds of general formula (IV)<1. In other embodiments of the invention it may be desirable to use a molar ratio of polyisocyanate to compounds of general formula (IV) of >1. Variation in this molar ratio has been found to markedly change the physical and chemical properties of the resulting polyurethane. For example, polyurethanes produced from the reaction of hexamethylene polyisocyanate and α-hydroxy oleic acid at a molar ratio of <1 result in the formation of highly tacky polymers, whereas when this molar ratio is >1 the resulting polyurethane is in the form of a crosslinked flexible foam.

The polyurethanes of the present invention can be produced as low molecular weight waxes or adhesive having a number average molecular as measured by GPC of up to about 2000 or 3000, through to linear or branched thermoplastic materials having a number average molecular as measured by GPC of up to about 200,000, through to thermoset crosslinked materials of infinite molecular weight.

The polyurethanes in accordance with the invention are expected to be useful as adhesives, sealants, coatings, films, fibres, moulded articles as well as foams or crosslinked rubbers.

The present invention will hereinafter be further described with reference to the following non-limiting examples.

### EXAMPLES

### General

Proton NMR spectra were obtained on Bruker AV400 and Brisker AV200 spectrometer, operating at 400 MHz and 200 MHz. All spectra were obtained at 23° C. unless specified. Chemical shifts are reported in parts per million (ppm) on the 5 scale and relative to the chloroform peak at 7.26 ppm (¹H) or the TMS peak at 0.00 ppm (¹H). Oven dried glassware was used in all reactions carried out under an inert atmosphere (either dry nitrogen or argon). All starting materials and reagents were obtained commercially unless otherwise stated. Removal of solvents “under reduced pressure” refers to the process of bulk solvent removal by rotary evaporation (low vacuum pump) followed by application of high vacuum pump (oil pump) for a minimum of 30 min. Analytical thin layer chromatography (TLC) was performed on plastic-backed Merck Kieselgel KG60F₂₅₄ silica plates and visualised using short wave ultraviolet light, potassium permanganate or phosphomolybdate dip. Flash chromatography was performed using 230-400 mesh Merck Silica Gel 60 following established guidelines under positive pressure. Tetrahydrofuran and dichloromethane were obtained from a solvent dispensing system under an inert atmosphere. All other reagents and solvents were used as purchased.

Molecular weights of polymers were characterized by gel permeation chromatography (GPC) performed in tetrahydrofuran (THF) or dimethylformamide (DMF) 1.0 mL/min, 25° C. using a Waters GPC instrument, with a Waters 2414 Refractive Index Detector, a series of four Polymer Laboratories PLGel columns (3×5 μm Mixed-C and 1×3 μm Mixed-E), and Empower Pro Software. The GPC was calibrated with narrow polydispersity polystyrene standards (Polymer Laboratories EasiCal, MW from 264 to 256000), and molecular weights are reported as polystyrene equivalents.

Thermal properties were measured using a Mettler Toledo DSC821e Differential Scanning calorimeter. Dried sample of the polymers were weighed into 40 ul flat base aluminium pans. The pans were crimp-fitted with the matching aluminium lid. An small hole was made in the lid with a 20 gauge needle to relieve any pressure. The pans were heated through the following temperature profile for analysis: (1) Heating 40 C to 220 C at 10 C/min; (2) Hold at 220 C. for 3 minutes; (3) Cool from 220 C to 30 C at 10 C/min; (4) Hold at 30 C for 3 minutes; (5) Heat from 30 C to 220 C at 10 C/minute.

Tensile testing was carried out using an Instron 5500R machine. Lap shear adhesive samples were prepared according to ASTM 3163 from Aluminium strips and polyethylene strip (ie 105 mm long by 25 mm wide).

### Monomer Synthesis and Characterisation

### 2-Hydroxy Fatty Acid Monomers

General Procedure A: Synthesis of Saturated 2-Hydroxy Fatty Acids from Saturated 2-Bromo Fatty Acids

Saturated 2-bromo fatty acid (1 equivalent) and KOH (4.4 equivalents) were suspended in water (vigorous stirring, 3 ml water per mmol 2-bromo fatty acid) and heated under reflux for 48 h. After 48 h the reaction mixture was cooled to room temperature brought to pH 1 by addition of half concentrated aqueous hydrochloric acid. The mixture was brought to reflux again (10 min), cooled to room temperature and extracted with diethyl ether (3×, ½ volume of the aqueous layer). The combined organic layers were washed with saturated aqueous ammonium chloride solution (1×, ½ volume of the organic layer), water (1×, volume of the organic layer) and brine (1×, ½ volume of the organic layer) and dried over sodium sulphate. After filtration, the organic solvent was removed under reduced pressure leaving the crude product. If necessary, the crude product was recrystallised from acetone.

### Synthesis of 2-hydroxy-nonanoic acid

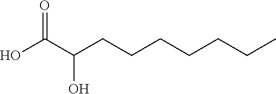

2-Bromo-nonanoic acid (22.6 g, 95.4 mmol) and potassium hydroxide (23.5 g, 419.7 mmol) were reacted in 300 ml water accordingly to general procedure A. The crude product was recrystallised from acetone (15.8 g, 90.6 mmol, 95%).

¹H-NMR (CDCl₃, 400 MHz): δ[ppm]=0.88 (tr, 3H, J=6.7 Hz), 1.28-1.53 (m, 8H), 1.65-1.74 (m, 1H), 1.81-1.91 (m, 1H), 4.27 (dd, 1H, J=7.5 Hz, 4.2 Hz)

### Synthesis of 2-hydroxy-hexadecanoic acid

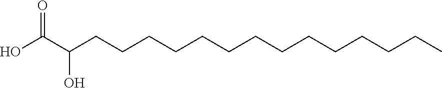

2-Bromo-hexadecanoic acid acid (10.0 g, 29.8 mmol) and potassium hydroxide (7.4 g, 131.1 mmol) were reacted in 90 ml water accordingly to general procedure A (8.0 g, 29.5 mmol, 99%).

¹H-NMR ((CD₃)₂CO, 200 MHz): δ[ppm]=0.91 (tr, 3H, J=6.1 Hz), 1.17-1.55 (m, 24H), 1.58-1.90 (m, 2H), 4.17 (dd, 1H, J=7.1 Hz, 4.2 Hz)

### Synthesis of 2-hydroxy-octadecanoic acid

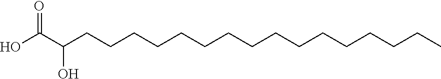

2-Bromo-octadecanoic acid acid (4.06 g, 11.2 mmol) and potassium hydroxide (2.8 g, 49.4 mmol) were reacted in 32 ml water accordingly to general procedure A. The crude product was recrystallised from acetone (3.3 g, 10.9 mmol, 97%).

¹H-NMR ((CD₃)₂SO, 400 MHz): δ[ppm]=0.89 (tr, 3H, J=6.6 Hz), 1.20-1.43 (m, 28H), 1.47-1.69 (m, 2H), 3.94 (dd, 1H, J=7.5 Hz, 4.6 Hz), 4.93-5.24 (br, 1H), 12.10-12.63 (br, 1H)

### Synthesis of (Z)-2-hydroxyoctadec-9-enoic acid

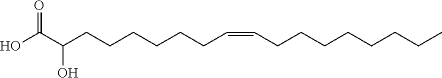

Anhydrous THF (70 ml) and diisopropylamine 5.0 ml, 35.4 mmol) were added to a dry flask flushed with argon and cooled to −30° C. n-Buthyllithium (1.6 M in hexane) (23.3 ml, 37.2 mmol) was added followed by (Z)-octadec-9-enoic acid (5.0 g, 17.7 mmol) in dry THF (20 ml) while maintaining the temperature at −30° C. Dianion formation was completed by heating the solution to 50° C. for 30 min and then cooling to room temperature. Oxygen was bubbled directly into the dianion solution at room temperature for 30 min. The reaction mixture was diluted with water (200 ml), acidified with 1N aqueous hydrochloric acid (pH 2) and extracted with diethylether 3×100 ml). The combined organic layers were washed with brine (1×100 ml) and dried over sodium sulphate. After filtration, the organic solvent was removed under reduced pressure leaving the crude product. The crude product was recrystallised from hexane (4.6 g, 15.4 mmol, 87%).

¹H-NMR (CDCl₃, 400 MHz): δ[ppm]=0.88 (tr, 3H, J=6.7 Hz), 1.22-1.53 (m, 20H), 1.65-1.76 (m, 1H), 1.80-1.92 (m, 1H), 1.96-2.06 (m, 4H), 4.28 (dd, 1H, J=7.5 Hz, 4.2 Hz), 5.29-5.39 (m, 2H)

### Synthesis of 2-hydroxyandec-10-enoic acid

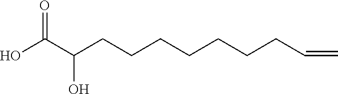

Anhydrous THF (70 ml) and diisopropylamine 5.0 ml, 35.4 mmol) were added to a dry flask flushed with argon and cooled to −30° C. n-Buthyllithium (1.6 M in hexane) (23.3 ml, 37.2 mmol) was added followed by undec-10-enoic acid (3.26 g, 17.7 mmol) in dry THF (20 ml) while maintaining the temperature at −30° C. Dianion formation was completed by heating the solution to 50° C. for 30 min and then cooling to room temperature. Oxygen was bubbled directly into the dianion solution at room temperature for 30 min. The reaction mixture was diluted with water (200 ml), acidified with 1N aqueous hydrochloric acid (pH 2) and extracted with diethylether 3×100 ml). The combined organic layers were washed with brine (1×100 ml) and dried over sodium sulphate. After filtration, the organic solvent was removed under reduced pressure leaving the crude product. The crude product was recrystallised from hexane (2.87 g, 14.3 mmol, 81%).

¹H-NMR (CDCl₃, 400 MHz): δ[ppm]=5.86-5.76 (m, 1H), 5.03-4.90 (m, 2H), 4.28 (dd, 1H, J¹=7.5 Hz, J²=4.2 Hz), 2.03 (dd, 2H, J¹=14.2 Hz, J²=6.8 Hz), 1.92-1.80 (m, 1H), 1.75-1.64 (m, 1H), 1.56-1.25 (m, 10H)

### Synthesis of 2,15-dihydroxypentadecanoic acid

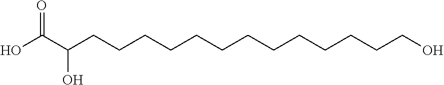

Methyl 2,15-dihydroxypentadecanoate* (10.0 g, 34.7 mmol) was dissolved in 100 ml of tetrahydrofuran. Potassium hydroxide (11.7 g, 208.0 mmol) dissolved in 300 ml of water was added over 1 h. The reaction mixture was stirred over night and after that acidified with half concentrated HCl (pH 1). The reaction mixture was extracted with ethyl acetate (3×200 ml), the combined organic layer was dried over Na₂SO₄ the organic solvents were removed under reduced pressure.

¹H-NMR (acetone, 200 MHz): δ[ppm]=4.11 (dd, 1H, J¹=7.1 Hz, J²=4.3 Hz), 3.51 (tr, 2H, J=6.3 Hz), 1.88-1.53 (m, 2H)

*Methyl 2,15-dihydroxypentadecanoate was synthesized through the subsequent ring opening of pentadecalactone to 15-hydroxypentadecanoic acid, the conversion of 15-hydroxypentadecanoic acid to the tetrahydropyranyl ether protected 15-hydroxypentadecanoic acid, the 2-hydroxylation of tetrahydropyranyl ether protected 15-hydroxypentadecanoic acid followed by the conversion into the starting material.

### Hydroxy-Capped 2-hydroxy Fatty Acids

### General procedure B: Synthesis of ethyleneglycol Capped 2-hydroxy Fatty Acids

A mixture of 2-hydroxy acid (1 equiv.), alkyl-diol (8.4 equiv.) and p-toluenesulfonic acid (0.01 equiv) in toluene (3× volume of ethylene glycol) was heated under reflux for 6 h. The forming water was removed continuously by using a Dean-Stark apparatus. The toluene was distilled off and the crude product was dissolved in chloroform (3× volume of ethylene glycol) and extracted with water (3×, equal chloroform volume). The combined organic layer was dried over sodium sulphate, filtered and the solvent was removed under reduced pressure leaving the product. The product was used without further purification.

### Synthesis of 2-hydroxyethyl 2-hydroxyhexadecanoate

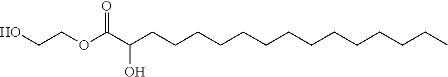

2-hydroxyhexadecanoic acid (23.7 g, 87.2 mmol), ethylene glycol (40.0 g, 645.6 mmol) and p-toluenesulfonic acid (0.7 mmol, 0.1 g) in toluene (90 ml) were reacted accordingly to general procedure B yielding 24.5 g (24.5 g, 77.5 mmol, 96%).

¹H-NMR (CDCl₃, 400 MHz): δ[ppm]=0.87 (tr, 3H, J=6.4 Hz), 1.07-1.53 (m, 24H), 1.59-1.73 (m, 1H), 1.75-1.88 (m, 1H), 3.68 (tr, 2H, J=4.6 Hz), 4.20-4.38 (m, 3H)

### Synthesis of 2-hydroxyethyl 2-hydroxyoctadecanoic acid

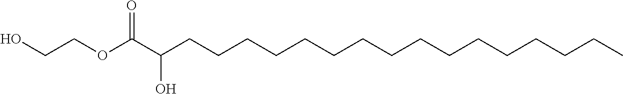

2-hydroxyoctadecanoic acid (22.0 g, 73.2 mmol), ethylene glycol (45.4 g, 614.9 mmol) and p-toluenesulfonic acid (0.7 mmol, 0.1 g) in toluene (90 ml) were reacted accordingly to general procedure B yielding 24.0 g (69.6 mmol, 24.0 g, 95%).

¹H-NMR (CDCl₃, 400 MHz): δ[ppm]=0.87 (tr, 3H, J=654 Hz), 1.11-1.57 (m, 26H), 1.55-1.71 (m, 1H), 1.73-1.91 (m, 1H), 3.67 (tr, 2H, J=4.6 Hz), 4.19-4.37 (m, 3H)

### Synthesis of (Z)-2-hydroxyethyl 2-hydroxyoctadec-9-enoate

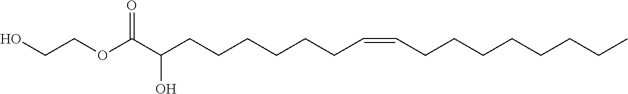

A mixture of (Z)-2-hydroxyoctadec-9-enoic acid (23.0 g, 77.1 mmol), ethylene glycol (40.0 g, 644.5 mmol) and p-toluenesulfonic acid (0.7 mmol, 0.1 g) was heated at 100° C. under high vacuum for 6 h. The crude product was cooled down to room temperature, dissolved in chloroform (90 ml) and extracted with water (3×100 ml). The organic layer was dried over sodium sulphate, filtered and the solvent was removed under reduced pressure leaving the product. The product was used without further purification (70.2, 24.0, 91%).

¹H-NMR (CDCl₃, 400 MHz): δ[ppm]=0.87 (tr, 3H, J=6.6 Hz), 1.26-1.42 (m, 20H), 1.59-1.69 (m, 1H), 1.73-1.84 (m, 1H), 1.97-2.05 (m, 4H), 2.64 (br, 3H), 3.83 (tr, 2H, J=4.8 Hz), 4.20-4.34 (m, 3H), 5.27-5.39 (m, 2H)

### Synthesis of 2-hydroxyethyl 2,15-dihydroxypentadecanoate

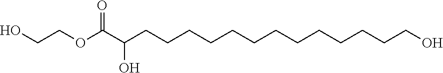

2,15-dihydroxypentadecanoic acid (23.9 g, 87.2 mmol), ethylene glycol (40.0 g, 645.6 mmol) and p-toluenesulfonic acid (0.7 mmol, 0.1 g) in toluene (90 ml) were reacted accordingly to general procedure B yielding 24.5 g (27.2 g, 85.5 mmol, 98%).

¹H-NMR (MeOD, 200 MHz): δ[ppm]=4.21-4.09 (m, 2H), 3.79-1.22 (m, 5H), 1.87-1.22 (m, 24H)

### Synthesis of 5-hydroxypentyl 2-hydroxyhexadecanoate

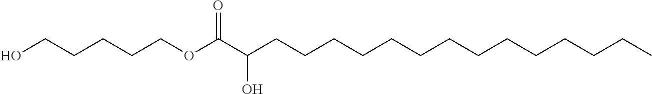

2-hydroxyhexadecanoic acid (15.0 g, 55.1 mmol), 1,6hexanediol (54.7 g, 462.8 mmol) and p-toluenesulfonic acid (0.7 mmol, 0.1 g) in toluene (120 ml) were reacted accordingly to general procedure B yielding 24.5 g (47.9 mmol, 17.8 g, 87%).

¹H-NMR (CDCl₃, 400 MHz): δ[ppm]=0.87 (tr, 3H, J=6.3 Hz), 1.18-1.48 (m, 2H), 1.53-1.84 (m, 4H), 3.65 (tr, 2H, J=6.4 Hz), 4.13-4.23 (m, 3H)

### General Procedure C: Synthesis of Dilactones Of 2-Hydroxy Acids

Selected 2-hydroxy acids were heated under vacuum at 120° C.-180° C. for 16 h-24 h. Under these conditions the forming water was removed continuously. The obtained products were used without further purification.

### Synthesis of 3,6-dibutyl-1,4-dioxane-2,5-dione

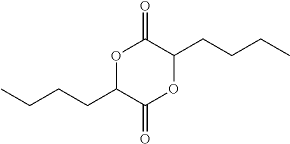

2-hydroxy hexanoic acid (20 g, 151.3 mmol) was reacted accordingly to general procedure C.

¹H-NMR (CDCl₃, 200 MHz): δ[ppm]=5.24-4.99 (m, 2H), 2.06-1.79 (m, 4H), 1.61-1.36 (m, 8H), 0.90 (tr, 6H, J=6.8 Hz)

### Synthesis of 3,6-dioctyl-1,4-dioxane-2,5-dione

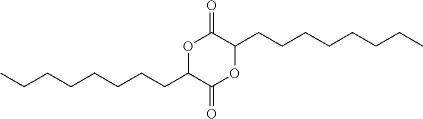

2-hydroxy decanoic acid (20 g, 106.2 mmol) was reacted accordingly to general procedure C.

¹H-NMR (CDCl₃, 200 MHz): δ[ppm]=5.22-5.07 (m, 2H), 2.04-1.88 (m, 4H), 1.62-1.27 (m, 24H), 0.87 (tr, 6H, J=5.8 Hz)

### Synthesis of 3,6-di(non-8-enyl)-1,4-dioxane-2,5-dione

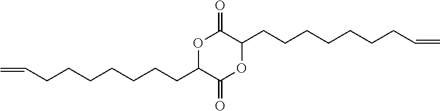

2-hydroxy undecenoic acid (20 g, 99.9 mmol) was reacted accordingly to general procedure C.

¹H-NMR (CDCl₃, 400 MHz): δ[ppm]=5.84-5.71 (m, 2H), 5.21-4.82 (m, 6H), 2.15-1.87 (m, 8H), 1.57-1.29 (m, 20H)

### Synthesis of 3,6-ditetradecyl-1,4-dioxane-2,5-dione

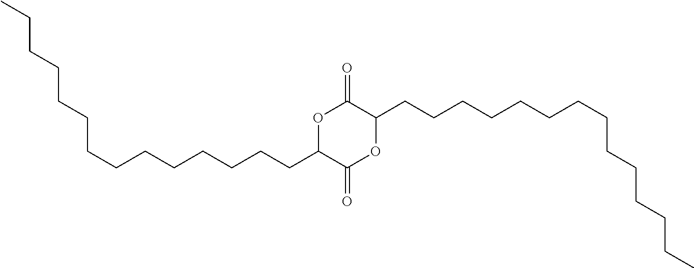

2-hydroxy hexadecanoic acid (20 g, 73.4 mmol) was reacted accordingly to general procedure C.

¹H-NMR (CDCl₃, 200 MHz): δ[ppm]=5.24-4.79 (m, 2H), 2.07-1.73 (m, 4H), 1.53-1.09 (m, 48H), 0.87 (tr, 6H, J=6.1 Hz)

### Synthesis of 3,6-di((Z)-hexadec-7-enyl)-1,4-dioxane-2,5-dione

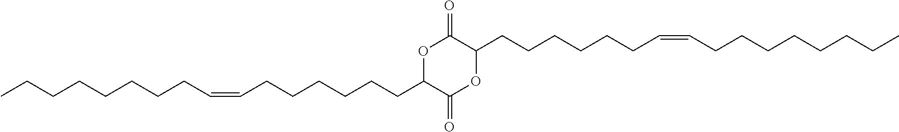

2-hydroxy oleic acid (20 g, 67.0 mmol) was reacted accordingly to general procedure C.

¹H-NMR (CDCl₃, 200 MHz): δ[ppm]=5.40-5.26 (m, 4H), 5.14-5.06 (m, 2H), 2.14-1.75 (m, 8H), 1.54-1.07 (m, 40H), 0.87 (tr, 6H, J=6.1 Hz)

### Synthesis of 3-methyl-6-tetradecyl-1,4-dioxane-2,5-dione [C3:C16:0 Lactone]

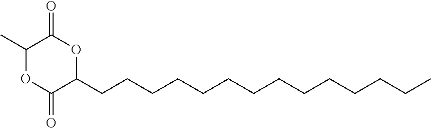

To 65.0 g (0.24 mol) 2-hydroxy-hexadecanoic acid 26.6 ml (0.25 mol) 2-bromopropionyl bromide were slowly added and stirred at 100° C. under nitrogen flow for 12 h while evolving HBr was neutralized. 1.9 l acetone and 66.6 ml (0.478 mol) triethylamine were added to the mixture and the solution was stirred at 60° C. for 3 h. After filtration of the triethylammonium bromide salts acetone and triethylamine were distilled off and the resulting mixture was dissolved in 1.0 l ethylacetate:hexane mixture (1:2). After filtration over silica gel, the solvents were distilled off and the remaining crude product was recrystallised from hexane at −20° C.

¹H-NMR (CDCl₃, 400 MHz): δ[ppm]=0.87 (tr, 3H, J=6.3 Hz), 1.17-1.63 (m, 26H), 1.66 (d, J=6.7 Hz) and 1.70 (d, J=6.7 Hz) (3H from 2 diastereomers), 1.89-2.17 (m, 2H), 4.82-4.95 (m, 1H), 4.96-5.08 (m, 1H)

### Polymer and Oligomer Synthesis and Characterisation

NMR-traces and Tensile-Lap Shear Testing data of selected fatty acid containing polyurethanes are illustrated in the Drawings.

### Procedure 1: 2-Step Procedure for Synthesis of Polyester Polyol

### Step 1: Synthesis of Lactic and 2-Hydroxy Fatty Acid Polyesters:

LACTIC ACID—2-HYDROXY OLEIC ACID POLYESTER: To a 50 mL RBF was added lactic acid (90% solution in water, mixture of D and L isomers) (18.92 g, 0.189 mol), the 2-hydroxy oleic acid (3.05 g, 0.010 mol), p-toluene sulphonic acid catalyst (100 mg) and toluene (8.0 g, 9.3 mL). The reaction flask was fitted with a Dean-Stark apparatus, stirred with a magnetic stirrer and refluxed with an oil bath temperature of 130° C. for 3 days. (The composition of the 30 g total batch polymerisations was 66% mass ratio of monomers, 95% mass ratio of lactic acid monomer to 5% mass ratio of 2-hydroxy fatty acid and 0.5% mass ratio of catalyst with respect to monomers).

Acid value: 58.4 mg KOH/g

GPC MW Mn: 3177, PD 2.9, Tg (DSC) 8.2° C.

LACTIC ACID—2-HYDROXY STEARIC ACID POLYESTER: To a 50 mL RBF was added lactic acid (90% solution in water, mixture of D and L isomers) (18.90 g, 0.189 mol), the 2-hydroxy stearic acid (2.99 g, 0.010 mol), p-toluene sulphonic acid catalyst (100 mg) and toluene (8.1 g, 9.4 mL). The reaction flask was fitted with a Dean-Stark apparatus, stirred with a magnetic stirrer and refluxed with an oil bath temperature of 130° C. for 3 days. (The composition of the 30 g total batch polymerisations was 66% mass ratio of monomers, 95% mass ratio of lactic acid monomer to 5% mass ratio of 2-hydroxy fatty acid and 0.5% mass ratio of catalyst with respect to monomers).

Acid Value: 48.6 mg KOH/g

GPC MW: 4945, PD 2.33, Tg (DSC) 9.4° C.

Characteristics of Polymers: Polyesters are low Tg, plasticized gums, opaque appearance.

### Step 2: Synthesis of Ethylene Glycol Capped Lactic Acid-2-Hydroxy Fatty Acid Polyols:

LACTIC ACID—2-HYDROXY OLEIC ACID POLYESTER POLYOL: To a solution of 14.86 g of polyester copolymer (acid value 58.4 mgKOH/g) in 18.3 ml of toluene was added 0.86 mL of ethylene glycol. The reaction vessel was fitted with a Dean-stark apparatus and the mixture stirred at an oil bath temp of 130° C. for 2 days. The composition of the mixture was 50% mass of solutes in solution.

ACID Value: 2.11 mg KOH/g

OH Value: 93.7 mg KOH/g

MW (based on acid and OH value): 1146 g/mol

LACTIC ACID—2-HYDROXY STEARIC ACID POLYESTER POLYOL: To a solution of 13.88 g of polyester copolymer (acid value 48.6 mgKOH/g) in 16.9 mL of toluene was added 0.67 mL of ethylene glycol. The reaction vessel was fitted with a Dean-stark apparatus and the mixture stirred at an oil bath temp of 130° C. for 2 days. The composition of the mixture was 50% mass of solutes in solution.

ACID Value: 1.05 mg KOH/g

OH Value: 85 mg KOH/g

MW (based on acid and OH value): 1288 g/mol

### Procedure 2: 1-Step Procedure for Synthesis of Polyester Polyol.

LACTIC ACID—2-HYDROXY OLEIC ACID POLYESTER POLYOL: To a 50 mL RBF was added lactic acid (90% solution in water, mixture of D and L isomers) (1.08 g, 0.012 mol), 2-hydroxy oleic acid (3.61 g, 0.012 mol), ethylene glycol (0.746 g, 0.012 mol), p-toluene sulphonic acid catalyst (30 mg) and toluene (6.9 g, 8 mL). The reaction flask was fitted with a Dean-Stark apparatus, stirred with a magnetic stirrer and refluxed with an oil bath temperature of 130° C. for 2 days. The composition of the 12.4 g total batch was 43% mass ratio of reagents and 0.3% mass ratio of catalyst with respect.

ACID Value: <0.05 mgKOH/g

OH Value: 155.08 mg KOH/g

MW (based on acid and OH value): 723 g/mol

Procedure 3: 1-Step Procedure for Synthesis of Fatty Acid Polyol

2-HYDROXY STEARIC ACID POLYOL: To a 50 mL RBF was added 2-hydroxy steric acid (9.77 g, 0.033 mol), ethylene glycol (0.674 g, 0.011 mol), p-toluene sulphonic acid catalyst (52 mg) and toluene (13.93 g, 16.10 mL). The reaction flask was fitted with a Dean-Stark apparatus, stirred with a magnetic stirrer and refluxed with an oil bath temperature of 130° C. for 2 days. The composition of the 24.4 g total batch was 43% mass ratio of reagents and 0.5% mass ratio of catalyst with respect to monomers.

Acid Value: 4.9 mg KOH/g

OH Value: 65.7 mg KOH/g

MW (based on acid and OH value): 1486 g/mol

GPC MWS MP's: 839, 1272, 1695, 2082: distinct oligomers

Procedure 4: Synthesis of POLY(ESTER-POLYURETHANES) from 2 hydroxy fatty acid containing polyester polyols

### Example 1

The polyester-urethane was prepared using 1,6-hexamethylene diisocyanate (HDI) as a chain extender and 60% by mass of hard segment. Typically the polyester polyol, LACTIC ACID/2-HYDROXY STEARIC ACID POLYESTER POLYOL) (11.36 g), ethylene glycol (4.2 g) dissolved in minimal toluene was transferred to a reaction vessel. The prepolymer mix was melted and heated to 100° C. to remove the toluene. The flask was then purged with a nitrogen stream and mixed thoroughly. The HDI (12.8 g) was then syringed in slowly until the mixture thickened considerably. Stirring was stopped immediately and the reaction vessel removed from heating.

The sample was placed in a vacuum oven at 100° C. purged with a nitrogen line overnight. It was then manually pelletised and compression moulded to create a flat moulded sample. Polymer: Example 1, an amorphous pliable yet weak polymer, with a Tg of approx. 30° C.

### Example 2

The polyester-urethane was prepared using 1,6-hexamethylene diisocyanate (HDI) as a chain extender and 60% by mass of hard segment. Typically the polyester polyol, LACTIC ACID/2-HYDROXY OLEIC ACID POLYESTER POLYOL (4.9 g), ethylene glycol (1.78 g) dissolved in minimal toluene was transferred to a reaction vessel. The prepolymer mix was melted and heated to 100° C. to remove the toluene. The flask was then purged with a nitrogen stream and mixed thoroughly. The HDI (5.56 g) was then syringed in until the mixture thickened considerably.

The polymer was dissolved in DMF and samples cast to create waxy films.

Polymer: Example 2, an amorphous white and waxy polymer, with a Tg of approx. 20° C.

MW by GPC: 21236 g/mol

### Example 3

The polyester-urethane was prepared using 1,6-hexamethylene diisocyanate (HDI) as a chain extender and 65% by mass of hard segment. Typically LACTIC ACID—2-HYDROXY OLEIC ACID POLYESTER POLYOL FE-1432-114LAHOA (4.35 g) and ethylene glycol (2.42 g) and Polycapralactone diol (MW 427) (1.12 g) were transferred to a glass beaker and degassed at 80° C. in a vacuum oven for 2 hours. Tin hexanoate (0.30 mL) was then added. HDI (7.98 g) was weighed into a wet-tarred pre-dried beaker and quickly poured into the polyol mixture while stirring rapidly under a nitrogen blanket. The mixture was quickly transferred to a metal container and cured at 100° C. in a vacuum oven purged with a nitrogen line overnight.

Polymer: Example 3, foamed white polyurethane polyester.

### Comparison Example

The polyester-urethane was synthesised on a Prism 16 mm co-rotating extruder using 1,6-hexamethylene diisocyanate (HDI) as a chain extender and 60% by mass of hard segment. The polyol mixture consisted of poly(lactic acid ethylene glycol polyol) (MW 438) (34.4 g), ethylene glycol (12.77 g) and oleic acid monoglyceride diol (8.59 g) which was fed into the extruder at a rate was 0.143 ml/min. HDI (51.7 g) was then introduced at a feed rate of 0.153 ml/min. The screw rpm was maintained at 150 rpm. The Comparison Example polymer was extruded as a straw-coloured, flexible yet weak material.

Tg (DSC) 10° C.

### Procedure 5: Synthesis of Polyether-Polyester Polyols for the Production of Polyurethanes

Polyether-polyester polyols were produced by the ring opening polymerisation of symmetric or asymmetric lactones made from 2-hydroxy fatty acids. A polyether polyol was used as the initiator for polymerisation. The polyether polyol used as a initiator was tetra-ethylene glycol (TEG).

The TEG (Aldrich) was dried by placing it in a round bottom flask (rbf) containing a magnetic stirrer bead. The flask was placed in an oil bath on a magnetic stirrer hotplate. The oil bath was set at 160° C. The TEG was heated and dried overnight to remove any water. A sample of the dried TEG was taken for proton NMR which was run in CDCl₃.

The polyether-polyester polyols were produced by weighing an amount of dried TEG into a dried rbf containing a magnetic stirrer. Next the dried lactone was added at an amount that was approximately 7 times the moles of the TEG. Next 10 drops of dibutyltin-dilaurate (DBTDL) [Aldrich] was added to the rbf. The flask was sealed with a stopper or vacuum tap and the mixture was transferred to an oil bath on a magnetic stirrer hotplate. The oil bath was set at. 160° C. The mixture was stirred for 12 hours while sealed and then vacuum was applied and the mixture heater for a further 2 hours. Samples of the polyether-polyester polyol were taken and analysed by GPC and NMR.

¹H-NMR of tetra-ethylene glycol (TEG)

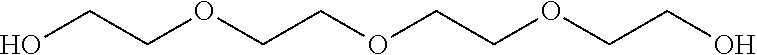

¹H-NMR (CDCl₃, 400 MHz): δ[ppm]=3.99-3.98 (m, 2H), 3.62 (tr, 4H, J=4.1 Hz), 3.59-3.54 (m, 8H), 3.51 (tr, 4H, J=4.9 Hz)

The triplet at 3.51 ppm represents the four protons next to the two primary alcohols in TEG. Subsequently the disappearance of this triplet will be used to determine if TEG has successfully reacted in ring opening polymerisations of symmetric or asymmetric lactones.

Reaction of tetra-ethylene glycol (TEG) with 3,6-dibutyl-1,4-dioxane-2,5-dione (Symmetric Dilactone of 2-hydroxy-hexanoic acid)

Tetra-ethylene glycol (TEG) (3.9 g, 20 mmol) was reacted with 3,6-dibutyl-1,4-dioxane-2,5-dione (symmetric dilactone of 2-hydroxy-hexanoic acid) (18.5 g, 140 mmol) accordingly to procedure 5. The ¹H-NMR of the crude product did not show any unreacted tetra-ethylene glycol (disappearance of the triplet at 3.51 ppm). This indicates that TEG has successfully reacted in a ring opening polymerisations of the symmetric lactone.

Reaction of tetra-ethylene Glycol (TEG) with 3,6-dioctyl-1,4-dioxane-2,5-dione (Symmetric Dilactone of 2-hydroxy-decanoic acid)

Tetra-ethylene glycol (TEG) (3.9 g, 20 mmol) was reacted with 3,6-dioctyl-1,4-dioxane-2,5-dione (symmetric dilactone of 2-hydroxy-decanoic acid) (26.4 g, 140 mmol) accordingly to procedure 5. The ¹H-NMR of the crude product did not show any unreacted tetra-ethylene glycol (disappearance of the triplet at 3.51 ppm). This indicates that TEG has successfully reacted in a ring opening polymerisations of the symmetric lactone.

Reaction of tetra-ethylene Glycol (TEG) with 3,6-di(non-8-enyl)-1,4-dioxane-2,5-dione (Symmetric Dilactone of 2-hydroxy-undecenoic acid)

Tetra-ethylene glycol (TEG) (3.9 g, 20 mmol) was reacted with 3,6-di(non-8-enyl)-1,4-dioxane-2,5-dione (symmetric dilactone of 2-hydroxy-undecenoic acid) (28.0 g, 140 mmol) accordingly to procedure 5. The ¹H-NMR of the crude product did not show any unreacted tetra-ethylene glycol (disappearance of the triplet at 3.51 ppm). This indicates that TEG has successfully reacted in a ring opening polymerisation of the symmetric lactone.

Reaction of tetra-ethylene Glycol (TEG) with 3,6-ditetradecyl-1,4-dioxane-2,5-dione (Symmetric Dilactone of 2-hydroxy-hexadecanoic acid)

Tetra-ethylene glycol (TEG) (3.9 g, 20 mmol) was reacted with 3,6-ditetradecyl-1,4-dioxane-2,5-dione (symmetric dilactone of 2-hydroxy-hexadecanoic acid) (38.1 g, 140 mmol) accordingly to procedure 5. The ¹H-NMR of the crude product did not show any unreacted tetra-ethylene glycol (disappearance of the triplet at 3.51 ppm). This indicates that TEG has successfully reacted in a ring opening polymerisations of the symmetric lactone.

Reaction of tetra-ethylene Glycol (TEG) with 3,6-di((Z)-hexadec-7-enyl)-1,4-dioxane-2,5-dione (Symmetric Dilactone of 2-hydroxy-oleic acid)

Tetra-ethylene glycol (TEG) (3.9 g, 20 mmol) was reacted with 3,6-di((Z)-hexadec-7-enyl)-1,4-dioxane-2,5-dione (symmetric dilactone of 2-hydroxy-oleic acid) (41.8 g, 140 mmol) accordingly to procedure 5. The ¹H-NMR of the crude product did not show any unreacted tetra-ethylene glycol (disappearance of the triplet at 3.51 ppm). This indicates that TEG has successfully reacted in a ring opening polymerisations of the symmetric lactone.

Reaction of tetra-ethylene Glycol (TEG) with 3-methyl-6-tetradecyl-1,4-dioxane-2,5-dione [C3:C16:0 Lactone]

Tetra-ethylene glycol (TEG) (3.9 g, 20 mmol) was reacted with 3-methyl-6-tetradecyl-1,4-dioxane-2,5-dione [C3:C16:0 Lactone] (45.7 g, 140 mmol) accordingly to procedure 5. The ¹H-NMR of the crude product did not show any unreacted tetra-ethylene glycol (disappearance of the triplet at 3.51 ppm). This indicates that TEG has successfully reacted in a ring opening polymerisations of the symmetric lactone.

### Procedure 6: Use of Polyether-Polyester Polyols in the Production of Polyurethanes

The dried polyether-polyester polyols (as described in procedure 5) were heated in stoppered round bottom flasks in a dry nitrogen flushed oven, set at 90° C. The polyether-polyester polyols were added to a clean, dried, tared glass beaker by placing the beaker under the inverted round bottom flask in the oven. The beaker was then weighed to determine the weight of polyether-polyester polyol added. The beaker was then returned to the oven to maintain dryness. Hexamethylene diisocyanate (HDI) was distilled before use. The required amounts of HDI was then weighed into the beaker containing the polyether-polyester polyol. Ten drops of dibutyltin dilaurate (DBTDL) catalyst were added and the materials were mixed vigorously using a metal spatula. The beaker was then placed in the oven again to heat for 5 mins. The mixture was again mixed and stirred vigorously with a spatula until the mixture thickened considerably before it was poured onto a silicone muffin tray. The tray was then placed in an oven overnight at 80° C. to cure the polymer.

The resulting polyurethanes were characterised by NMR, GPC and DSC.

Reaction of polyether-polyester polyol (from the Reaction of tetra-ethylene glycol (TEG) with 3,6-dibutyl-1,4-dioxane-2,5-dione (symmetric dilactone of 2-hydroxy-hexanoic acid)) with HDI

Polyether-polyester polyol (from the reaction of tetra-ethylene glycol (TEG) with 3,6-dibutyl-1,4-dioxane-2,5-dione (symmetric dilactone of 2-hydroxy-hexanoic acid)) was reacted with HDI accordingly to procedure 6. The proton NMR (¹H-NMR (DMSO), 400 MHz) showed characteristic multiplets between 4.88 ppm-4.71 ppm and 3.04 ppm-2.87 ppm proving the formation of polyurethanes with HDI.

A comparative example was also produced by reacting the lactone of lactic acid with TEG and then reacting the resulting polyether-polyester with HDI.

The resulting polyether-polyester polyurethanes were found to flexible materials. The degree of flexibility increasing with the length of the chain length of the 2 hydroxy fatty acid.

Polyurethane synthesis from Monomeric Capped and Uncapped Fatty Acid

### Materials:

The polycaprolactone, PCLD (CAPA 2100A) (molecular weight˜1000) was obtained from Era Polymer Pty Ltd. and dried at 80° C. under high vacuum (0.1 torr) for 2-3 hours prior to use. The fatty acid modifiers (with and without ethylene glycol or 1,6-hexane diol capped) were also dried at 80° C. under high vacuum (0.1 torr) for 2-3 hours prior to use them. The 1,6-hexamethylene diisocyanate (HDI) was obtained from Aldrich and was distilled. Diphenylmethane-4,4-diisocyanate (MDI) was obtained from Orica Polyurethane and was dried at 90° C. under high vacuum (0.1 torr) for about 2-3 hours. The chain extender 1,4-butanediol (BDO) was received from Aldrich as 99% mass fraction purity and used as received. The BDO was also dried at 80° C. under high vacuum (0.1 torr) for 2-3 hours prior to use them. The catalyst dibutyltin dilaurate (DBTDL) was obtained from Aldrich and was used as received.

### Synthesis:

A PU formulation was made based on the isocyanate (HDI or MDI) proportion that kept as 50 mol % which gives rise to a range of hard segment proportion over the full composition of the PUs synthesised. The FA modifier and/or polyester polyol (PCLD) and/or chain extender (BDO) were varied in the formulation over a range of PU composition. The catalyst (DBTDL) concentration was always kept constant as 0.1 mol %.

A mixture of pre-weighed FA modifier and/or polyester polyol and/or chain extender were placed and mixed in a 100 ml pre-dried polypropylene beaker and heated to 80° C. in an air oven. Then the catalyst (DBTDL) was weighed, added to the beaker and mixed well with a plastic spatula and kept the mixture in oven for 10 minutes. The isocyanate content of the formulation was converted to its corresponding volume and added to the mixture using a plastic syringe fitted with needle. The mixture was stirred manually until gelation occurred (60-90 seconds), the viscous mixture was then poured onto a Teflon coated metal tray to cure at 90° C. for 1 hour. The temperature was then dropped down to 80° C. and allowed the curing for more 21 hours in the oven.

### Example Formulation

For a PU composition of PCLD 30 wt %, BDO 10 wt %, FA modifier—(ethylene glycol capped) 2-OH Oleic acid 10 wt %, catalyst (DBTDL) 0.1 wt % and HDI 50 wt %, the mixture of PCLD (17.5018 g), BDO (0.5513 g) EG-20H Oleic acid (1.9993 g), DBTDL (0.0756 g) was reacted with 4.9 ml HDI.

### Preparation and Testing of Samples for Adhesiveness by Tensile Lap Shear Method

The substrates were cleaned using hot water with washing in acetone followed by drying with a clean cotton cloth. The substrates were stores on clean paper towel on Teflon coated trays and were covered with paper towel until needed.

Preparation of adhesive samples: The lap shear samples were prepared in replicated of 5 by melt pressing at 100° C. for 5 min, followed by water cooling of the press. The samples were laid up on Teflon sheet between steel press plates. Teflon strips were used as the removable shims to control the spread of the adhesive polyurethane sample.

The sample used for testing was Example 31 which was a tacky clear to honey coloured material with a high adhesiveness to a range of materials (skin, paper, polyolefins and metals).

Samples were conditioned in a controlled temperature and humidity room for 48 hours prior to testing. Samples were tested according to ASTM 3163 at a crosshead speed of 1.27 mm/min or at a constant shear rate of 8.5 MPa/min.

### Lap Shear Testing of Example 31 as a Adhesive Between Aluminium Strips

The sample (from Example 31) was heated and melt pressed between two cleaned aluminium strips to a thickness of 0.5 mm using Teflon coated glass film as a shim. The aluminium strips were cleaned according to the testing standard. The aluminium strips were set to have the tabs diametrically opposed. The samples were then equilibrated in a controlled humidity lab for 24 hours prior to testing.

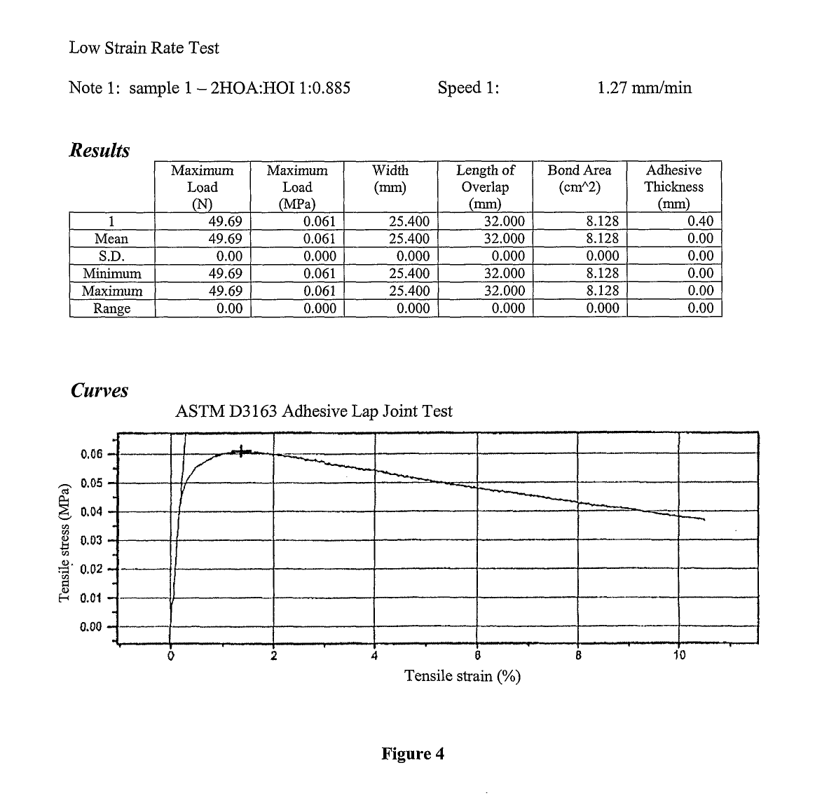

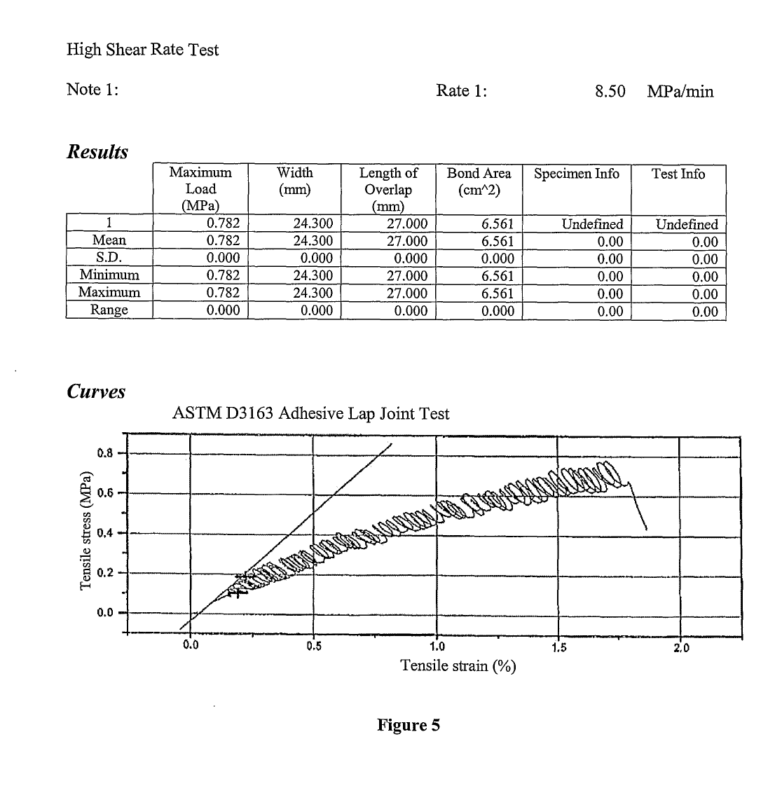

The results of the adhesive lap shear testing for the bonding of sample 31 to an aluminium substrate at low and high shear rate testing conditions (see FIGS. 4 and 5) show that the PU does behave as an adhesive by showing some stress (resistance) to the applied strain. At low shear the yields/fails by slip/creep from within the bulk of the adhesive rather than at the adhesive-aluminium interface. At high shear rate the sample yields/fails by a combination of crazing (delamination from the adhesive-aluminium interface) and creep. Overall the results indicate reasonable adhesion to an aluminium substrate.

### Lap Shear Testing of Example 31 as a Adhesive Between Polyethylene Strips

The sample (from Example 31) was heated and melt pressed between two cleaned polyethylene strips to a thickness of 0.5 mm using Teflon coated glass film as a shim. The polyethylene strips were cleaned according to the testing standard. The polyethylene strips were set to have the tabs diametrically opposed. The samples were then equilibrated in a controlled humidity lab for 24 hours prior to testing.

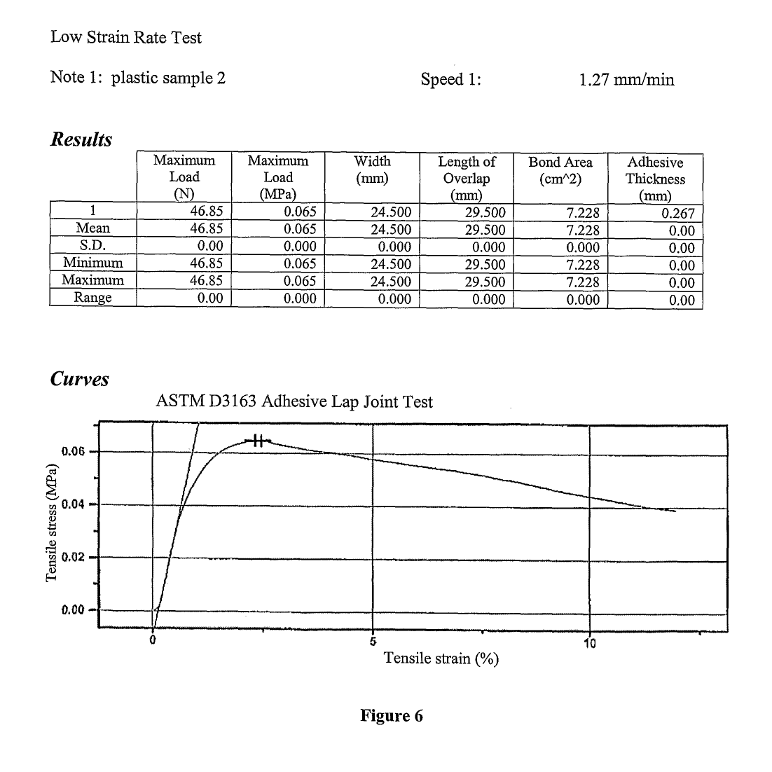

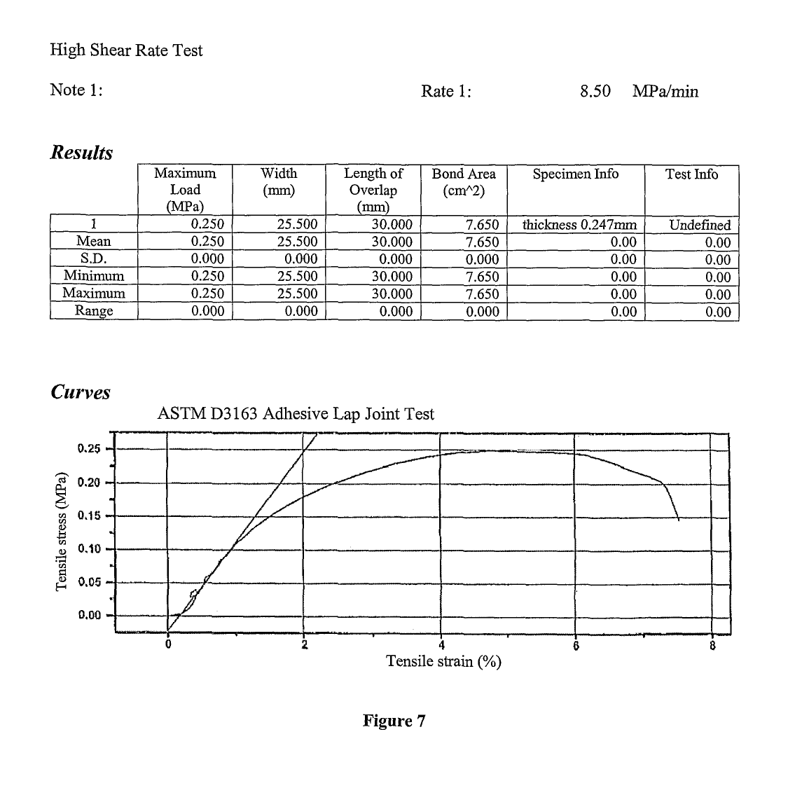

The results of the adhesive lap shear testing for the bonding of example 31 to an polyethylene substrate at low and high shear rate testing conditions (see FIGS. 6 and 7) show that the PU does behave as an adhesive by showing some stress (resistance) to the applied strain. At low shear the yields/fails by slip/creep from within the bulk of the adhesive rather than at the adhesive-polyethylene interface. At high shear rate the sample yields/fails by a combination of slip/creep. Overall the results indicate reasonable adhesion to a polyethylene substrate

Polyurethane Examples prepared from Monomeric Capped and Uncapped Fatty Acids
Synthesised HDI based PUs (EG or 1, 6 Hexane Diol Capped FA Modifier)

| Example | |
|---|---|
| No | PU composition |
| 4 | PCLD50, EG-2OH Oleic acid0, BDO0 & HDI50 |
| 5 | PCLD45, EG-2OH Oleic acid5, BDO0 & HDI 50 |
| 6 | PCLD40, EG-2OH Oleic acid10, BDO0 & HDI50 |
| 7 | PCLD30, EG-2OH Oleic acid20, BDO0 & HDI50 |
| 8 | PCLD20, EG-2OHOleic acid30, BDO0 & HDI50 |
| 9 | PCLD20, EG-2OH Oleic acid20, BDO10 & HDI50 |
| 10 | PCLD30, EG-2OH Oleic acid10, BDO10 & HDI50 |
| 11 | PCLD10, EG-2OH Oleic acid20, BDO20 & HDI50 |
| 12 | PCLD10, EG-2OH Oleic acid10, BDO30 & HDI50 |
| 13 | PCLD0, EG-2OH Oleic acid20, BDO30 & HDI50 |
| 14 | PCLD0, EG-2OH Oleic acid50, BDO0 & HDI50 |
| 15 | EG-2OH hexadecanoic acid and HDI |
| | (1:1 mole proportion) |
| 16 | EG-2OH hexadecanoic acid and HDI |
| | (1:0.885 mole proportion) |
| 17* | 1,6-hexane diol capped hexadecanoic acid and HDI |
| | (1:1 mole proportion) |
| 18 | 1,6-hexane diol capped hexadecanoic acid and HDI |
| | (1:0.885 mole proportion) |
| 18a | EG capped 2,15-dihydroxypentadecanoic acid and HDI |
| | (1:1.5 mole proportion) |

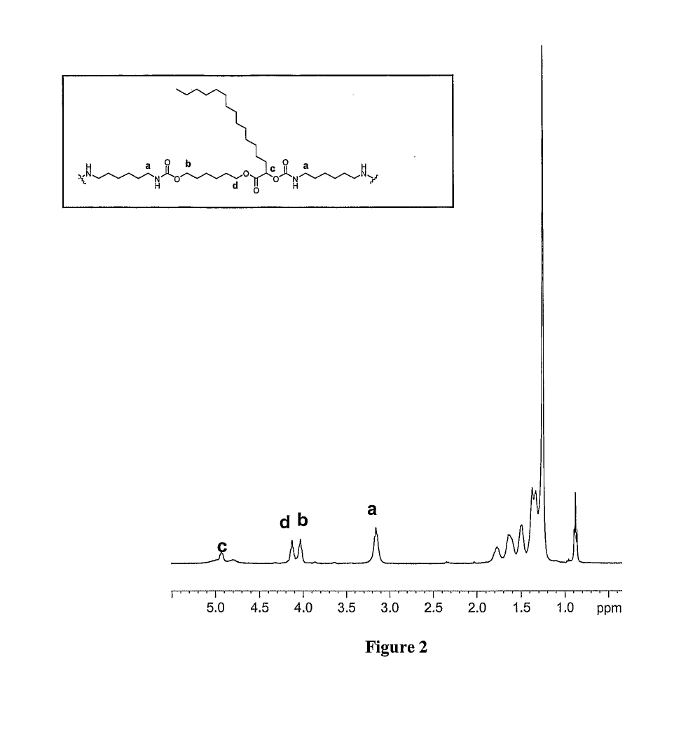

*For NMR spectrum of product see FIG. 2

### Synthesised HDI Based PUs (Uncapped FA Modifier)

| Example | |
|---|---|
| No | PU composition |
| 19 | PCLD502OH-Oleic acid0, BDO0 & HDI50 (CBIPU-16) |
| 20 | PCLD45, 20H-Oleic acid5, BDO0 & HDI50 (CBIPU-17) |
| 21 | PCLD40, 2OH-Oleic acid10, BDO0 & HDI50 (CBIPU-18) |
| 22 | PCLD30, 2OH-Oleic acid20, BDO0 & HDI50 (CBIPU-19) |
| 23 | PCLD20, 2OH-Oleic acid30, BDO0 & HDI 50 (CBIPU-20) |
| 24 | PCLD10, 2OH-Oleic acid10, BDO30 & HDI50 (CBIPU-21) |
| 25 | PCLD20, 2-OH Oleic acid10, BDO20 &HDI50 (CBIPU-22) |
| 26 | PCLD20, 2-OH Oleic acid20, BDO10 & HDI50 (CBIPU-23) |
| 27 | PCLD0, 2-OH Oleic acid20, BDO30 & HDI50 (CBIPU-24) |
| 28 | 2-OH hexadecanoic acid & HDI (1:1 mole proportion) |
| 29 | 2-OH hexadecanoic acid & HDI (1:0.995 mole proportion) |
| 30 | 2-OH hexadecanoic acid & HDI (1:0.990 mole proportion) |
| 31 | 2-OH hexadecanoic acid & HDI (1:0.885 mole proportion) |
| 31a | 2-OH hexanoic acid & HDI (1:1 mole proportion) |
| 31b | 2-hydroxydecanoic acid and HDI (1:1 mole proportion) |
| 31c | 2-hydroxyundec-10-enoic acid and HDI |
| | (1:1 mole proportion) |
| 31d | 2-hydroxyoctadec-9-enoic acid and HDI |
| | (1:1 mole proportion) |
| 31e | 2,15-dihydroxypentadecanoic acid and HDI |
| | (1:1.5 mole proportion) |
| 31f* | 2-OH oleic acid & HDI (1:1 mole proportion) |

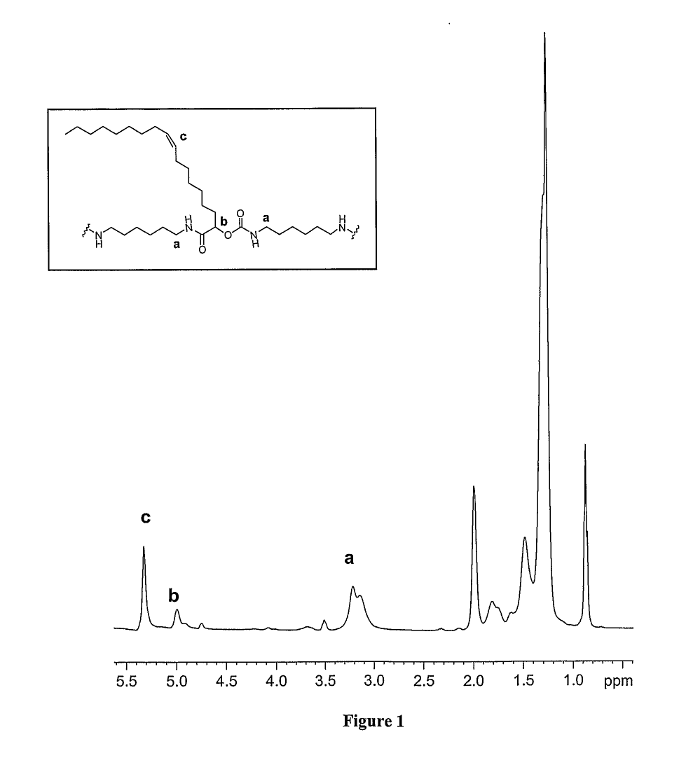

*For NMR spectrum of product see FIG. 1

### Synthesised MDI Based PUs (EG Capped FA Modifier)

| Example | |
|---|---|
| No | PU composition |
| 32 | PCLD40, EG-2OH Oleic acid10, BDO0 & MDI 50 |
| 33 | PCLD0, EG-2OH Oleic acid 50, BDO0 & MDI 50 |
| 34 | PCLD20, EG-2OH Oleic acid10, BDO20 & MDI 50 |
| 35 | PCLD0, EG-2OH Oleic acid20, BDO30 & MDI 50 |
| 35 a* | EG-2OH oleic acid and MDI (1:1 mole proportion) |

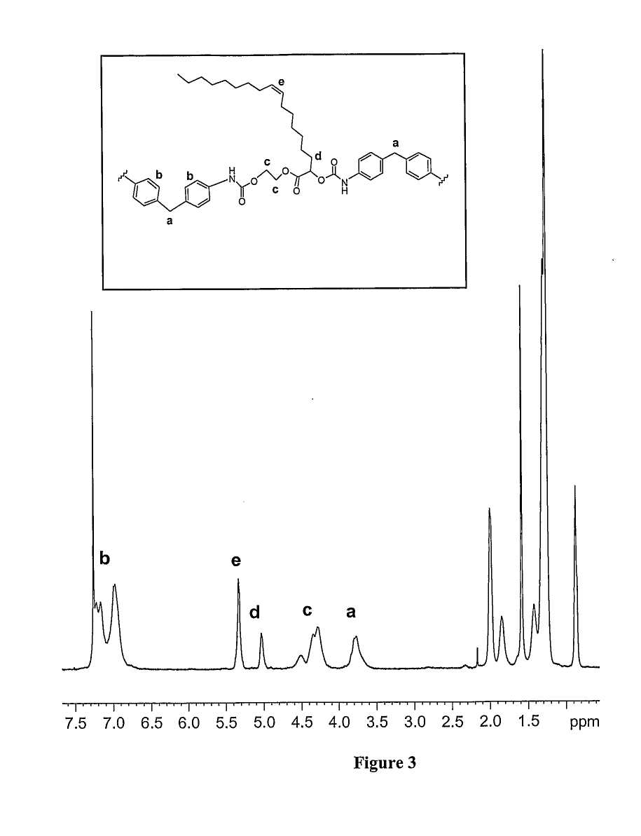

*For NMR spectrum of product see FIG. 3

### Synthesised MDI Based PUs (Uncapped FA Modifier)

| Example | |
|---|---|
| No | PU composition |
| 36 | PCLD50, 2-OH Oleic acid0, BDO0 & MDI50 |
| 37 | PCLD40, 2-OH Oleic acid10, BDO0 & MDI50 |
| 38 | PCLD0, 2-OH Oleic acid 50, BDO30 & MDI50 |
| 39 | PCLD10, 2-OH Oleic acid10, BDO30 &MDI50 |
| 40 | PCLD0, 2-OH Oleic acid20, BDO30 & MDI50 |
| 41 | PCLD0, 2-OH Oleic50, BDO0 & MDI50 |
| 42 | 2-OH hexanoic acid & MDI (1:1 mole proportion) |
| 43 | 2-OH decanoic acid & MDI (1:1 mole proportion) |
| 44 | 2-OH hexadecanoic acid & MDI (1:1 mole proportion) |
| 45 | 2-hydroxyundec-10-enoic acid and HDI (1:1 mole proportion) |
| 46 | 2-hydroxyoctadec-9-enoic acid and HDI (1:1 mole proportion) |

PUs Made from Polyether-Polyester Polyols

| Example | |
|---|---|
| No | PU composition |
| Comparitive Ex 1 | [TEG 10 C3/C3 70] 50 & HDI 50 |
| 47 | [TEG 10 C6/C6 70] 50 & HDI 50 |
| 48 | [TEG 10 C11:1/C11:1 70] 50 & HDI 50 |
| 49 | [TEG 10 C3/C16 70] 50 & HDI 50 |

### DSC

| Example | | |
|---|---|---|
| No | Composition | Tg (C.) |
| 31a | 2-OH hexanoic acid & HDI | 29.1 |
| 31b | 2-hydroxydecanoic acid and HDI | 24.7 |
| 28 | 2-OH hexadecanoic acid & HDI | 17.8 |
| 31c | 2-hydroxyundec-10-enoic acid and HDI | 10.2 |
| 31d | 2-hydroxyoctadec-9-enoic acid and HDI | 9.1 |

| | | | Tm J/g |
|---|---|---|---|
| | | | S—Start |
| Example | | | P—Peak |
| No | Composition | Tg (C.) | E—End |
| 42 | 2-OH hexanoic acid & MDI | 45 | — |
| 43 | 2-OH decanoic acid & MDI | 67 | 7.5 J/g |
| | | | S—130 C. |
| | | | P—156 C. |
| | | | E—178 C. |
| 44 | 2-OH hexadecanoic acid & MDI | 64 | 9.5 J/g |
| | | | S—158 C. |
| | | | P—185 C. |
| | | | E—195 C. |
| 45 | 2-hydroxyundec-10-enoic acid and HDI | 30 | 2.9 J/g |
| | | | S—90 C. |
| | | | P—117 |
| | | | E—128 C. |
| 46 | 2-hydroxyoctadec-9-enoic acid and HDI | 25 | 7.5 J/g |
| | | | S—71 C. |
| | | | P—108 C. |
| | | | E—121 C. |

### GPS

| Example | Composition | Mn | Mw | Mp | PD |
|---|---|---|---|---|---|
| Polyol 1 | TEG - C3/C3 | 1219 | 1493 | 1423 | 1.22 |
| Polyol 2 | TEG - C6/C6 | 1625 | 2631 | 2548 | 1.62 |
| Polyol 4 | TEG - C3/C16 | 1687 | 2022 | 1984 | 1.20 |
| 31c | 2-hydroxyundec-10-enoic | 2846 | 5553 | 4662 | 1.95 |
| | acid and HDI | | | | |

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A polyurethane polymer comprising as part of its polymer backbone an α-oxy carbonyl moiety of general formula (I): 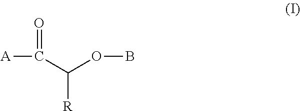
where A and B represent the remainder of the polymer backbone and are the same or different, and R is an optionally substituted aliphatic hydrocarbon having three or more carbon atoms.

2. The polyurethane polymer according to claim 1, wherein the α-oxy carbonyl moiety is present in a portion of the polymer backbone represented by general formula (II): 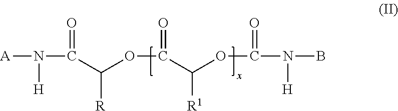
where A, B and R are as defined in claim 1, R¹ is an optionally substituted aliphatic hydrocarbon, and x is 0 or an integer ranging from 1 to 100, wherein for each repeat unit x when x≧2, R¹ is the same or different.

3. The polyurethane polymer according to claim 1, wherein the α-oxy carbonyl moiety is present in a portion of the polymer backbone represented by general formula (III): 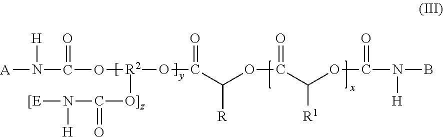
where A, B and R are as defined in claim 1, R¹ is an optionally substituted aliphatic hydrocarbon, and x is 0 or an integer ranging from 1 to 100, wherein for each repeat unit x when x≧2, R¹ is the same or different, E represents with A and B the remainder of the polymer backbone, R² is a z+2 valent moiety selected from optionally substituted alkylene, optionally substituted alkenylene, optionally substituted arylene, and optionally substituted alkylene-arylene-alkylene, y is an integer ranging from 1 to 100, wherein for each repeat unit y when y≧2, R² is the same or different, and z is 0 or an integer ranging from 1 to 20.

4. The polyurethane polymer according to claim 1, wherein the aliphatic hydrocarbon group R comprises 3 to about 40 carbon atoms.

5. The polyurethane polymer according to claim 1, wherein the aliphatic hydrocarbon group R is unsaturated.

6. The polyurethane polymer according to claim 1, wherein the aliphatic hydrocarbon group R is an optionally substituted acyclic aliphatic hydrocarbon.

7. The polyurethane polymer according to claim 1, wherein the α-oxy carbonyl moiety comprising the aliphatic hydrocarbon group R is a residue of an α-hydroxy acid selected from α-hydroxy valeric acid, α-hydroxy caproic acid, α-hydroxy caprylic acid, α-hydroxy pelargonic acid, α-hydroxy capric acid, α-hydroxy lauric acid, α-hydroxy mytistic acid, α-hydroxy palmitic acid, α-hydroxy margaric acid, α-hydroxy stearic acid, α-hydroxy arachidic acid, α-hydroxy behenic acid, α-hydroxy lignoceric acid, α-hydroxy cerotic acid, α-hydroxy carboceric acid, α-hydroxy montanic acid, α-hydroxy melissic acid, α-hydroxy lacceroic acid, α-hydroxy ceromelissic acid, α-hydroxy geddic acid, α-hydroxy ceroplastic acid, α-hydroxy obtusilic acid, α-hydroxy caproleic acid, α-hydroxy lauroleic acid, α-hydroxy linderic acid, α-hydroxy myristoleic acid, α-hydroxy physeteric acid, α-hydroxy tsuzuic acid, α-hydroxy palmitoleic acid, α-hydroxy sapienic acid, α-hydroxy petroselinic acid, α-hydroxy oleic acid, α-hydroxy elaidic acid, α-hydroxy vaccenic acid, α-hydroxy gadoleic acid, α-hydroxy gondoic acid, α-hydroxy cetoleic acid, α-hydroxy erucic acid, α-hydroxy nervonic acid, α-hydroxy linoleic acid, α-hydroxy γ-linolenic acid, α-hydroxy dihomo-γ-linolenic acid, α-hydroxy arachidonic acid, α-hydroxy α-linolenic acid, α-hydroxy steridonic acid, α-hydroxy nisinic acid, and α-hydroxy Mead Acid.

8. A method of preparing a polyurethane polymer, said method comprising forming a urethane linkage through reaction of a compound comprising an isocyanate functional group and a compound of general formula (IV): 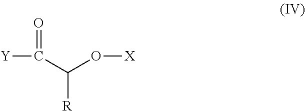
where Y is OH or —[—O—R²(OH)_{z}—]_{y}—OH, X is H or —[—C(O)CH(R¹)O—]ₓ—H, R is an optionally substituted aliphatic hydrocarbon having three or more carbon atoms, R¹ is an optionally substituted aliphatic hydrocarbon, and x is a positive integer ranging from 1 to 100, wherein for each repeat unit x when x≧2, R¹ is the same or different, R² is a z+2 valent moiety selected from optionally substituted alkylene, optionally substituted alkenylene, optionally substituted arylene, and optionally substituted alkylene-arylene-alkylene, y is an integer ranging from 1 to 100, wherein for each repeat unit y when y≧2, R² is the same or different, and z is 0 or an integer ranging from 1 to 20.

9. The method according to claim 8, wherein the compound comprising the isocyanate functional group is selected from m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,3-cyclohexane diisocyanate, 1,4-cyclohexane diisocyanate, hexahydro-toluene diisocyanate and its isomers, isophorone diisocyanate, dicyclo-hexylmethane diisocyanates, 1,5-napthylene diisocyanate, 4,4′-diphenylmethane diisocyanate, 2,4′ diphenylmethane diisocyanate, 4,4′-biphenylene diisocyanate, 3,3′-dimethoxy-4,4′-biphenylene diisocyanate, 3,3′-dimethyl-diphenylpropane-4,4′-diisocyanate, 2,4,6-toluene triisocyanate, 4,4′-dimethyl-diphenylmethane-2,2′,5,5′-tetraisocyanate and polymethylene polyphenylpolyisocyanate.

10. The method according to claim 8, wherein the aliphatic hydrocarbon group R comprises 3 to about 40 carbon atoms.

11. The method according to claim 8, wherein the aliphatic hydrocarbon group R is unsaturated.

12. The method according to claim 8, wherein the aliphatic hydrocarbon group R is an acyclic aliphatic hydrocarbon.

13. The method according to claim 8, wherein the α-oxy carbonyl moiety of general formula (IV) is a residue of an α-hydroxy acid selected from α-hydroxy valeric acid, α-hydroxy caproic acid, α-hydroxy caprylic acid, α-hydroxy pelargonic acid, α-hydroxy capric acid, α-hydroxy lauric acid, α-hydroxy mytistic acid, α-hydroxy palmitic acid, α-hydroxy margaric acid, α-hydroxy stearic acid, α-hydroxy arachidic acid, α-hydroxy behenic acid, α-hydroxy lignoceric acid, α-hydroxy cerotic acid, α-hydroxy carboceric acid, α-hydroxy montanic acid, α-hydroxy melissic acid, α-hydroxy lacceroic acid, α-hydroxy ceromelissic acid, α-hydroxy geddic acid, α-hydroxy ceroplastic acid, α-hydroxy obtusilic acid, α-hydroxy caproleic acid, α-hydroxy lauroleic acid, α-hydroxy linderic acid, α-hydroxy myristoleic acid, α-hydroxy physeteric acid, α-hydroxy tsuzuic acid, α-hydroxy palmitoleic acid, α-hydroxy sapienic acid, α-hydroxy petroselinic acid, α-hydroxy oleic acid, α-hydroxy elaidic acid, α-hydroxy vaccenic acid, α-hydroxy gadoleic acid, α-hydroxy gondoic acid, α-hydroxy cetoleic acid, α-hydroxy erucic acid, α-hydroxy nervonic acid, α-hydroxy linoleic acid, α-hydroxy γ-linolenic acid, α-hydroxy dihomo-γ-linolenic acid, α-hydroxy arachidonic acid, α-hydroxy α-linolenic acid, α-hydroxy steridonic acid, α-hydroxy nisinic acid, and α-hydroxy Mead Acid.

14. The method according to claim 8, wherein the compound of general formula (IV) is prepared by reacting a polyol with a cyclic ester having at least two ester moieties that form part of its cycle, wherein said cycle comprises an α-oxy carbonyl moiety of general formula (VI): 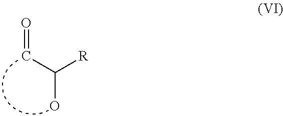
where R is as defined in claim 8.

15. Use of a compound of general formula (IV) in the manufacture of polyurethane polymer, 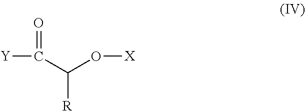
where Y is OH or —[—O—R²(OH)_{z}—]_{y}—OH, X is H or —[—C(O)CH(R¹)O—]ₓ—H, R is an optionally substituted aliphatic hydrocarbon having three or more carbon atoms, R¹ is an optionally substituted aliphatic hydrocarbon, and x is a positive integer ranging from 1 to 100, wherein for each repeat unit x when x≧2, R¹ is the same or different, R² is a z+2 valent moiety selected from optionally substituted alkylene, optionally substituted alkenylene, optionally substituted arylene, and optionally substituted alkylene-arylene-alkylene, y is an integer ranging from 1 to 100, wherein for each repeat unit y when y≧2, R² is the same or different, and z is 0 or an integer ranging from 1 to 20.

16. A foam, elastomer, moulded, coatings, fibre, sealant or adhesive product comprising a polyurethane polymer according to claim 1.
